(19) United States
(12) Patent Application Publication
(10) Pub. No.: US 2019/0128088 A1
(43) Pub. Date: May 2, 2019

(54) PLUG ASSEMBLY FOR A PIPE SYSTEM

(71) Applicant: Wellfirst Technologies Inc., Houston, TX (US)

(72) Inventors: John MacDonald, Calgary (CA); Sean Gillis, Beaumont (CA)

(73) Assignee: Wellfirst Technologies Inc., Houston, TX (US)

(21) Appl. No.: 15/798,934

(22) Filed: Oct. 31, 2017

(51) Int. Cl. E21B 33/12; F16L 55/10; F16L 55/11; E21B 33/124

(52) U.S. Cl. CPC E21B 33/1208; E21B 33/124; F16L 55/11; F16L 55/1011

(57) ABSTRACT

A plug assembly including a sleeve defining a primary channel, and a plug blocking the primary channel. One or more components of the plug assembly may be dissolvable. A pipe system including a pipe, a first plug assembly, a second plug assembly, and a fluid sealed within the pipe between the plug assemblies. At least one of the plug assemblies includes a sleeve defining a primary channel and a plug blocking the primary channel. One or more components of the plug assemblies may be dissolvable. A method for inserting a pipe system into a wellbore, including providing the pipe system, which includes a first plug assembly and a second plug assembly, sealing a fluid between the plug assemblies, inserting the pipe system into the wellbore, and unsealing the plug assemblies. The method may include dissolving one or more components of one or both of the plug assemblies.

### TECHNICAL FIELD

A plug assembly for sealing a pipe, a pipe system including two or more plug assemblies, and a method for inserting into a wellbore a pipe system including two or more plug assemblies.

### BACKGROUND OF THE INVENTION

In the oil and gas industry, pipe is often inserted into a wellbore after drilling. In some circumstances, it may be difficult to overcome the forces which resist the insertion of pipe into a wellbore. As one example, for deviated wellbores with long deviated sections, overcoming friction forces between the pipe and the wellbore, either by reducing the friction forces or by increasing string weight or pull down forces, cam be difficult and/or require expensive equipment.

### SUMMARY OF THE INVENTION

References in this document to orientations, to operating parameters, to ranges, to lower limits of ranges, and to upper limits of ranges are not intended to provide strict boundaries for the scope of the invention, but should be construed to mean “approximately” or “about” or “substantially”, within the scope of the teachings of this document, unless expressly stated otherwise.

As used herein, “proximal” means located relatively toward an “uphole”, “surface”, or “originating” location, and “distal” means located relatively away from an “uphole”, “surface”, or “originating” location.

This description is directed in part to a plug assembly for sealing a pipe, to a pipe system including two or more plug assemblies, and to a method for inserting a pipe system into a wellbore, wherein the pipe system includes two or more plug assemblies.

The plug assembly described herein may be used for sealing any pipe having a pipe bore, and may be particularly suited for use in circumstances in which it may be necessary or desirable to seal a pipe temporarily.

The plug assembly comprises a sleeve which defines a primary channel extending through the sleeve, and a plug for blocking the primary channel. The sleeve is configured to be positionable within the pipe bore of a selected pipe in order to seal the pipe. The plug is configured to block the primary channel of the sleeve. In some embodiments, the plug assembly may be configured so that the primary channel of the sleeve can be selectively unblocked. The primary channel of the sleeve may be selectively unblocked in any suitable manner. In some embodiments, the plug may be breakable and/or releasable in order to unblock the primary channel.

The pipe system described herein comprises a pipe defining a pipe bore, a first plug assembly sealing the pipe bore, a second plug assembly sealing the pipe bore, and a fluid sealed within the pipe bore between the first plug assembly and the second plug assembly. At least one of the first plug assembly and the second plug assembly may comprise a sleeve which defines a primary channel extending through the sleeve, and a plug for blocking the primary channel. The sleeve may be positioned within the pipe bore such that a seal is provided between the sleeve and the pipe.

The pipe system may be used for any purpose, and may be particularly suited for use in a wellbore, including but not limited to a wellbore for the production of hydrocarbons such as oil and/or gas. As non-limiting examples, the pipe system may comprise casing, liner, tubing, and/or any other type of pipe which may be inserted into a wellbore.

The pipe system may be sealed between adjacent plug assemblies by the plug assemblies. The pipe system may include a fluid contained within the pipe bore between the adjacent plug assemblies. The fluid which is contained between adjacent plug assemblies may be any substance or combination of substances which substantially exhibits the properties of a fluid under the conditions in which the pipe system is used, and may include solid particles.

The fluid which is contained between adjacent plug assemblies may have any density which is suitable for the intended use of the pipe system. As non-limiting examples, the fluid which is contained between adjacent plug assemblies may have a density which is greater than, less than, or equal to the density of a wellbore fluid which is likely to be contained in the wellbore into which the pipe system is to be inserted.

In some particular embodiments of the pipe system described herein, a fluid having a density less than the density of a wellbore fluid may be contained between the first plug assembly and the second plug assembly, and a fluid having a density equal to or greater than the density of the wellbore fluid may be contained within the pipe bore proximal to the first plug assembly.

The method described herein for inserting a pipe system into a wellbore may comprise providing the pipe system. The pipe system may comprise a pipe defining a pipe bore, a first plug assembly sealing the pipe bore, and a second plug assembly sealing the pipe bore. The method may comprise sealing a fluid within the pipe bore between the first plug assembly and the second plug assembly. The method may comprise inserting the pipe system into the wellbore. The method may comprise unsealing the first plug assembly and the second plug assembly. At least one of the first plug assembly and the second plug assembly may comprise a sleeve which defines a primary channel extending through the sleeve, and a plug for blocking the primary channel. The sleeve may be positioned within the pipe bore such that a seal is provided between the sleeve and the pipe.

The method described herein for inserting a pipe system into a wellbore may be used in any wellbore, including but not limited to a vertical wellbore or a deviated wellbore, and may be particularly suited for use in a wellbore in which the forces resisting the insertion of the pipe system into the wellbore may otherwise be difficult to overcome. As non-limiting examples, the method may be particularly suited for use in a vertical wellbore in which a wellbore fluid contained in the wellbore provides a buoyant force to the pipe system which may be difficult to overcome, or in a deviated wellbore in which friction forces between the pipe system and the wellbore may be difficult to overcome.

One or more portions of a plug assembly, a first plug assembly, and/or a second plug assembly may be dissolvable. As used herein, “dissolvable” or “dissolving” means that the dissolvable portion or portions of the plug assembly fully or partially disintegrate in any manner in the presence of a disintegrating agent. As non-limiting examples, the dissolvable portion or portions of the plug assembly may disintegrate physically and/or chemically. As non-limiting examples, the dissoluble portion or portions of the plug assembly may dissolve to become a disintegrated solid, a phase of a dispersion, a phase of an emulsion, or a constituent of a solution. The dissolvable portion or portions of the plug assembly may disintegrate in the presence of the same disintegrating agent, or different portions of the plug assembly may disintegrate in the presence of different disintegrating agents.

A disintegrating agent may be any substance or combination of substances which is capable of interacting with a dissolvable portion of the plug assembly in order to disintegrate the dissolvable portion of the plug assembly. A disintegrating agent may be a gas, a liquid, a solid, or a combination or a component thereof.

One or more disintegrating agents may be contained in a delivery fluid, or one or more disintegrating agents may be provided in some other manner. In some embodiments, the delivery fluid may comprise, consist of, or consist essentially of a wellbore fluid.

A wellbore fluid may comprise, consist of, or consist essentially of any substance or combination of substances which may naturally be present in a wellbore and/or which may be introduced into a wellbore. A wellbore fluid may comprise solid particles. As non-limiting examples, a wellbore fluid may comprise, consist of, or consist essentially of oil, gas, water, brine, cement, dialing fluid, and/or wellbore treating fluid. As non-limiting examples, drilling fluid may comprise, consist of, or consist essentially of a water-based drilling fluid, an oil-based drilling fluid, and/or a synthetic-based drilling fluid. As non-limiting examples, wellbore treating fluid may comprise, consist of, or consist essentially of water, an acid, a base, a salt and/or any other fluid which may be introduced into a wellbore in order to complete and/or treat the wellbore.

In a non-limiting first aspect, a plug assembly may comprise:
(a) a sleeve for positioning within the pipe bore such that a seal is provided between the sleeve and the pipe, wherein the sleeve has a proximal end and a distal end, wherein the sleeve defines a primary channel extending through the sleeve from the proximal end to the distal end; and
b) a plug blocking the primary channel.

In a non-limiting second aspect, a pipe system may comprise:
(a) a pipe, wherein the pipe defines a pipe bore;
(b) a first plug assembly sealing the pipe bore and a second plug assembly sealing the pipe bore, wherein the second plug assembly is separated from the first plug assembly by a distance within the pipe bore, wherein the second plug assembly is distal to the first plug assembly, and wherein at least one of the first plug assembly and the second plug assembly comprises:
   (i) a sleeve positioned within the pipe bore such that a seal is provided between the sleeve and the pipe, wherein the sleeve has a proximal end and a distal end, and wherein the sleeve defines a primary channel extending through the sleeve from the proximal end to the distal end; and
   (ii) a plug blocking the primary channel; and
(c) a fluid sealed within the pipe bore between the first plug assembly and the second plug assembly.

In a non-limiting third aspect, a method for inserting a pipe system into a wellbore may comprise:
(a) providing the pipe system, wherein the pipe system comprises:
   (i) a pipe, wherein the pipe defines a pipe bore;
   (ii) a first plug assembly sealing the pipe bore and a second plug assembly sealing the pipe bore, wherein the second plug assembly is separated from the first plug assembly by a distance within the pipe bore, wherein the second plug assembly is distal to the first plug assembly, and wherein at least one of the first plug assembly and the second plug assembly comprises:
      (i) a sleeve positioned within the pipe bore such that a seal is provided between the sleeve and the pipe, wherein the sleeve has a proximal end and a distal end, and wherein the sleeve defines a primary channel extending through the sleeve from the proximal end to the distal end; and
      (ii) a plug blocking the primary channel; and
(b) sealing a fluid within the pipe bore between the first plug assembly and the second plug assembly;
(c) inserting the pipe system into the wellbore; and
(d) unsealing the first plug assembly and the second plug assembly.

In the second and third aspects, the first plug assembly, the second plug assembly, and/or both the first plug assembly may comprise a sleeve which defines a primary channel extending through the sleeve and a plug blocking the primary channel.

More particularly, in the second and third aspects, the first plug assembly may comprise a first sleeve defining a first primary channel and a first plug blocking the first primary channel, and/or the second plug assembly may comprise second sleeve defining a second primary channel and a second plug blocking the second primary channel.

In some embodiments of the second and third aspects, if the first plug assembly comprises a first sleeve defining a first primary channel and a first plug, the second plug assembly may comprise, consist of, or consist essentially of any structure, device, and/or apparatus which is capable of performing the function or functions of the second plug assembly. As a non-limiting example in such embodiments, the second plug assembly may comprise, consist of, or consist essentially of a second plug. In such embodiments, the second plug may be positioned within the pipe bore such that a seal is provided between the second plug and the pipe. In some such embodiments, the second plug assembly may not comprise a second sleeve.

In some embodiments of the second and third aspects, if the second plug assembly comprises a second sleeve defining a second primary channel and a second plug, the first plug assembly may comprise, consist of, or consist essentially of any structure, device, and/or apparatus which is capable of performing the function or functions of the first plug assembly. As a non-limiting example, in such embodiments, the first plug assembly may comprise, consist of, or consist essentially of a first plug. In such embodiments, the first plug may be positioned within the pipe bore such that a seal is provided between the first plug and the pipe. In some such embodiments, the first plug assembly may not comprise a first sleeve.

In the various aspects, a sleeve, a first sleeve, and/or a second sleeve may each comprise, consist, or consist essentially of any structure, device, and/or apparatus which is capable of providing a seal between the sleeve and the pipe and is capable of providing the primary channel, and may be constructed of any material or combination of materials which is capable of providing these functions.

In some embodiments of the various aspects, a sleeve may be dissolvable in the presence of one or more disintegrating agents. The one or more disintegrating agents may be contained in a delivery fluid. The delivery fluid may comprise, consist of, or consist essentially of any fluid which is capable of containing the one or more disintegrating agents. In some embodiments, the delivery fluid may comprise, consist or consist essentially of a wellbore fluid.

In some particular embodiments of the various aspects, a sleeve may be dissolvable in the presence of a sleeve disintegrating agent, a first sleeve may be dissolvable in the presence of a first sleeve disintegrating agent, and/or a second sleeve may be dissolvable in the presence of a second sleeve disintegrating agent. The first sleeve disintegrating agent may be the same as the second sleeve disintegrating agent or may be different than the second sleeve disintegrating agent. Dissolving a sleeve, a first sleeve, and/or a second sleeve may be particularly suitable in circumstances in which it may be desirable to achieve a substantially unobstructed pipe bore.

A dissolvable sleeve may comprise, consist or consist essentially of any material or combination of materials capable of dissolving in the presence of its associated disintegrating agent. As a non-limiting example, a dissolvable sleeve may comprise, consist of, or consist essentially of a suitable metal such as a dissolvable magnesium alloy. As non-limiting examples, the dissolvable magnesium alloy may comprise, consist of, or consist essentially of a SoluMag™ dissolvable magnesium alloy manufactured by Magnesium Elektron and/or a TervAlloy™ dissolvable magnesium alloy manufactured by Terves Inc.

In some embodiments of the various aspects, a dissolvable sleeve may be shaped to enhance a rate at which the sleeve dissolves. As a non-limiting example, a dissolvable sleeve may be shaped so that it defines one or a plurality of secondary channels in communication with at least one of the primary channel, the proximal end of the sleeve, and the distal end of the sleeve, for enhancing the rate at which the sleeve dissolves. As a non-limiting example, a dissolvable sleeve may be shaped so that the primary channel defines contours, such as waves, ridges and/or a taper, for enhancing the rate at which the sleeve dissolves. In some embodiments, a dissolvable sleeve may be shaped to reduce the rate at which the sleeve dissolves.

In each of the various aspects, the pipe bore has a bore cross-sectional area. The bore-cross-sectional area is defined and bounded by an inner circumference of the pipe.

In each of the various aspects, a plug assembly has a plug assembly cross-sectional area. In each of the various aspects, a plug assembly cross-sectional area may be substantially equal to the bore cross-sectional area so that the plug assembly can seal the pipe bore.

In the first aspect, the primary channel has a primary channel cross-sectional area. In the second and third aspects, if the first plug assembly comprises a first sleeve which defines a first primary channel, the first primary channel has a first primary channel cross-sectional area, and if the second plug assembly composes a second sleeve which defines a second primary channel, the second primary channel has a second primary channel cross-sectional area. The primary channel cross-sectional area, the first primary channel cross-sectional area, and/or the second primary channel cross-sectional area may each independently be selected to be less than, greater than, or equal to 50 percent of the bore cross-sectional area.

A primary channel cross-sectional area may be selected having regard to any consideration, including but not limited to the overall configuration of the wellbore, the nature of the equipment and/or other objects which may be present in the wellbore and/or in the pipe, and/or the chosen method for inserting the pipe system into the wellbore. As non-limiting examples, a primary channel cross-sectional area may be selected with the objective of controlling the rate at which the sleeve dissolves, controlling a primary channel flow rate, and/or accommodating or blocking a transfer of objects through the primary channel. As a non-limiting example, a primary channel cross-sectional area (and thus the size of the plug, the first plug and/or the second plug) may also be selected so that the plug, first plug and/or the second plug is capable of being passed through restrictions and/or reduced diameter sections of the pipe after the primary channel has been unblocked.

In the second and third aspects, if the first plug assembly comprises, consists of, or consists essentially of a first plug, the first plug has a first plug cross-sectional area, and if the second plug assembly comprises, consists of, or consists essentially of a second plug, the second plug has a second plug cross-sectional area. The first plug cross-sectional area and/or the second plug cross-sectional area may both independently be selected to be less than, greater than, or equal to 50 percent of the bore cross-sectional area.

If the first plug assembly comprises a first sleeve defining a first primary channel and a first plug, the first plug cross-sectional area may in some embodiments be substantially equal to the first primary channel cross-sectional area. If the first plug assembly comprises a first plug but does not comprise a first sleeve, the first plug cross-sectional area may in some embodiments be substantially equal to the bore cross-sectional area.

If the second plug assembly comprises a second sleeve defining a second primary channel and a second plug, the second plug cross-sectional area may in some embodiments be substantially equal to the second primary channel cross-sectional area. If the second plug assembly comprises a second plug but does not comprise a second sleeve, the second plug cross-sectional area may in some embodiments be substantially equal to the bore cross-sectional area.

In the various aspects in which a plug assembly comprises a sleeve which defines a primary channel, a plug, a first plug, and/or a second plug may each comprise, consist of, or consist essentially of any structure, device, and/or apparatus which is capable of blocking the primary channel, and may be constructed of any material or combination of materials which is capable of blocking the primary channel. As non-limiting examples, a plug may be configured to fit within the primacy channel in order to block the primary channel, and/or a plug may be configured to block the primary channel by covering the proximal end of the sleeve and/or the distal end of the sleeve.

In the various aspects in which a plug assembly does not comprise a sleeve, a plug, a first plug and/or a second plug may each comprise, consist of, or consist essentially of any structure, device, and/or apparatus which is capable of sealing the pipe bore, and may be constructed of any material or combination of materials which is capable of blocking the pipe bore. As a non-limiting example, a plug may be configured to fit within the pipe bore in order to block the pipe bore.

In some embodiments of the various aspects, a plug may be dissolvable in the presence of one or more disintegrating agents. In one or more disintegrating agents may be contained in a delivery fluid, or the one or more disintegrating agents may be provided in some other manner. The delivery fluid may comprise, consist of, or consist essentially of a wellbore fluid. In some particular embodiments, a plug may be dissolvable in the presence of a plug disintegrating agent, a first plug may be dissolvable in the presence of a first plug disintegrating agent, and/or a second plug may be dissolvable in the presence of a second plug disintegrating agent. The first plug disintegrating agent may be the same as the second plug disintegrating agent or may be different than the second plug disintegrating agent.

A dissolvable plug may comprise, consist of, or consist essentially of any material or combination of materials capable of dissolving in the presence of its associated disintegrating agent. As a non-limiting example, a dissolvable plug may comprise, consist of, or consist essentially of a suitable metal such as a dissolvable magnesium alloy. As non-limiting examples, the dissolvable magnesium alloy may comprise, consist of, or consist essentially of a SoluMag™ dissolvable magnesium alloy manufactured by Magnesium Elektron and/or a TervAlloy™ dissolvable magnesium alloy manufactured by Terves Inc.

In some embodiments of the various aspects, other components of a plug assembly in addition to or in substitution for the sleeve and/or the plug may be dissolvable in the presence of one or more disintegrating agents. Such other components of the plug assembly may be dissolvable in the presence of the same disintegrating agent or different disintegrating agents, which may be the same or different from a sleeve disintegrating agent and/or a plug disintegrating agent.

In some embodiments of the various aspects, the one or more disintegrating agents may be the same for each component of each plug assembly. In some embodiments of the various aspects, the one or more disintegrating agents may be different for some or all of the components of a plug assembly. In some embodiments of the various aspects, the one or more disintegrating agents may be different for some or all of the plug assemblies. In some embodiments of the various aspects, the one or more disintegrating agents may be different for some or all of the components of some or all of the plug assemblies.

In some embodiments in which a sleeve is shaped to define a plurality of secondary channels, the plug may block the primary channel so that the plug prevents communication between the proximal end of the sleeve and at least some of the secondary channels, and/or so that the plug prevents communication between the distal end of the sleeve and at least some of the secondary channels.

In some embodiments of the various aspects, a plug assembly, a first plug assembly, and/or a second plug assembly may be configured so that it may be selectively unsealed.

In some embodiments in which a plug assembly comprises a sleeve which defines a primary channel and a plug blocking the primary channel, the plug assembly may be selectively unsealed by unblocking the primary channel.

In some embodiments in which a plug assembly comprises a plug but does not comprise a sleeve, the plug assembly may be selectively unsealed by breaking the plug and/or by releasing the plug from the pipe bore.

In embodiments in which a plug assembly comprises a sleeve which defines a primary channel and a plug blocking the primary channel, the primary channel may be selectively unblocked in any suitable manner. In some embodiments, the primary channel may be selectively blocked by breaking the plug and/or by releasing the plug from the primary channel.

As a result, in some embodiments of the various aspects, a plug of a plug assembly may be breakable and/or releasable in order to unseal the plug assembly and/or unblock the primary channel of a sleeve.

A plug may be breakable and/or releasable in any suitable manner. As non-limiting examples, a plug may be breakable and/or releasable by increasing a pressure within the pipe bore and/or by applying a force or impact to the plug.

As a non-limiting example, a plug may comprise, consist of, or consist essentially of a device which is configured to rupture in response to pressure, and the plug may be breakable by increasing a pressure within the pipe bore in order to rupture the device. As a non-limiting example, the plug may comprise, consist of, or consist essentially of a burst plug or a similar device.

As a non-limiting example, a plug may be configured to break by applying a force or impact to the plug. As a non-limiting example, the plug may be partially or fully constructed of a relatively brittle material which is breakable in response to a force or impact being applied to the plug.

As a non-limiting example, a plug assembly may comprise a retaining device for retaining a plug, so that it blocks the pipe bore or the primary channel, and the plug may be releasable by releasing the retaining device. A retaining device may comprise, consist of, or consist essentially of any structure, device, and/or apparatus which is capable of releasably retaining the plug so that it blocks the pipe bore or the primary channel. A retaining device may be configured to be capable of resisting forces which are expected to be exerted on the plug in either a proximal direction or a distal direction during insertion of the pipe system into a wellbore, while being capable of being released when unblocking of the pipe bore or the primary channel, is desired.

In some embodiments, a retaining device may be actuatable to release a plug. As a non-limiting example, a plug may be configured to fit within the pipe bore or the primary channel and the retaining device may comprise a latch which is configured to be actuated to release the plug from the pipe bore or the primary channel in response to a pressure or a force being applied to the plug. A latch may comprise, consist of, or consist essentially of any structure, device, and/or apparatus which is capable of performing the functions of a releasable retaining device. As non-limiting examples, a latch may comprise, consist of, or consist essentially of a detent mechanism, a collet mechanism, and/or a garter spring mechanism.

In some embodiments, a retaining device may be breakable in order to release a plug. As a non-limiting example, a plug may be configured to fit within a pipe bore or a primary channel and the retaining device may comprise one or more breakable elements which are configured to break to release the plug from the pipe bore or the primary channel in response to a pressure or a force being applied to the plug. As a non-limiting example, the one or more breakable elements may comprise one or more shear pins. A shear pin may comprise, consist of, or consist essentially of any structure, device, and/or apparatus which is capable of performing the functions of a shear pin, and may be threaded or non-threaded.

In some embodiments of the various aspects, a retaining device may be dissolvable in the presence of a retaining device disintegrating agent.

In some embodiments of the various aspects, a plug assembly, a first plug assembly, and/or a second plug assembly may comprise a stop for resisting movement of the plug assembly in a proximal or uphole direction relative to the pipe, which may otherwise be caused by buoyancy or other forces acting on the plug assembly, the first plug assembly, and/or the second plug assembly. The stop may comprise, consist of, or consist essentially of any structure, device, and/or apparatus which is capable of resisting the relative movement. As a non-limiting example, the step may comprise, consist of, or consist essentially of a retaining ring, which may be connected with the pipe and/or with the plug assembly and which may extend from the pipe into the pipe bore or which may extend from the plug assembly into the pipe bore.

In some embodiments of the various aspects, a stop may be dissolvable in the presence of a stop disintegrating agent.

In the second aspect and the third aspect, the fluid contained in the pipe bore between the first plug assembly and the second plug assembly may comprise, consist of, or consist essentially of any suitable fluid or combination of fluids, and may contain solid particles. The fluid contained in the pipe bore between the first plug assembly and the second plug assembly may have a density which is greater than, less than, or equal to that of a wellbore fluid which is likely to be contained within the wellbore. As a non-limiting example, the fluid contained in the pipe bore may comprise, consist of, or consist essentially of air and/or an inert gas.

In the second aspect and the third aspect, a fluid may also be contained in the pipe bore proximal to the first plug assembly. The fluid contained in the pipe bore proximal to the first plug assembly may have a density which is greater than, less than, or equal to that of a wellbore fluid which is likely to be contained in the wellbore. As a non-limiting example, if the fluid contained in the pipe bore between the first plug assembly and the second plug assembly has a density which is less than that of the wellbore fluid, the fluid contained in the pipe bore proximal to the first plug assembly may have a density which is equal to or greater than that of the wellbore fluid. As a non-limiting example, the fluid which is contained in the pipe bore proximal to the first plug assembly may be a delivery fluid. As a non-limiting example, the delivery fluid may comprise, consist of, or consist essentially of a wellbore fluid.

In some embodiments of the second aspect and the third aspect in which the first plug assembly comprises a first sleeve defining a first primary channel, the first primary channel cross-sectional area may be chosen to either permit or block a transfer of objects, such as components of the second plug assembly, through the first primary channel. In some embodiments of the second aspect and the third aspect in which the second plug assembly comprises a second sleeve defining a second primary channel, the second primary channel, cross-sectional area may be chosen to either permit or block a transfer of objects, such as components of the first plug assembly, through the second primary channel.

In some embodiments of the second aspect and the third aspect in which the first plug assembly comprises a first sleeve defining a first primary channel and the second plug assembly comprises a second sleeve defining a second primary channel, the first primary cross-sectional area may be greater than 50 percent of the bore cross-sectional area and the second primary channel cross-sectional area may be less than 50 percent of the bore cross-sectional area.

In some embodiments of the second aspect and the third aspect in which the first plug assembly comprises a first sleeve defining a first primary channel and the second plug assembly comprises a second sleeve defining a second primary channel, the first primary cross-sectional area may be less than 50 percent of the bore cross-sectional area and the second primary channel cross-sectional area may be greater than 50 percent of the bore cross-sectional area.

In some embodiments of the second aspect and the third aspect in which the first plug assembly comprises a first sleeve defining a first primary channel and the second plug assembly comprises a second sleeve defining a second primary channel, the first primary cross-sectional area may be less than 50 percent of the bore cross-sectional area and the second primary channel cross-sectional area may be less than 50 percent of the bore cross-sectional area.

In some embodiments of the second aspect and the third aspect in which the first plug assembly comprises a first sleeve defining a first primary channel and the second plug assembly comprises a second sleeve defining a second primary channel, the first primary cross-sectional area may be greater than 50 percent of the bore cross-sectional area and the second primary channel cross-sectional area may be greater than 50 percent of the bore cross-sectional area.

In some embodiments of the second aspect and the third aspect, the pipe system may comprise one or more additional plug assemblies in addition to the first plug assembly and the second plug assembly. In such embodiments, such additional plug assemblies may be similar or identical to, or different from, the plug assembly of the first aspect or may be similar or identical to, or different from, the first plug assemblies and/or the second plug assemblies of the second and third aspects.

In some particular embodiments of the second aspect and the third aspect, the pipe system may further comprise a third plug assembly sealing the pipe bore. In such particular embodiments, the third plug assembly may be separated from the first plug assembly by a distance within the pipe bore, such that the third plug assembly is proximal to the first plug assembly. In some such particular embodiments, the third plug assembly may be similar or identical to the plug assembly of the first aspect or to one of the first plug assemblies or the second plug assemblies of the second and third aspects. In some particular embodiments, the third plug assembly may be different from the plug assembly of the first aspect and from the first plug assemblies and the second plug assemblies of the second and third aspects.

In some particular embodiments of the second aspect and the third aspect, the third plug assembly may comprise:
(a) a third sleeve for positioning within the pipe bore such that a seal is provided between the third sleeve and the pipe, wherein the third sleeve has a proximal end and a distal end, wherein the third sleeve defines a third primary channel extending through the third sleeve from the proximal end to the distal end; and
(b) a third plug for blocking the third primary channel.

In some particular embodiments of the second aspect and the third aspect, a fluid may be contained in the pipe bore between the third plug assembly and the first plug assembly. The fluid contained in the pipe bore between the third plug assembly and the first plug assembly may have a density which is greater than, less than, or equal to that of a wellbore fluid which is likely to be contained in the wellbore. As a non-limiting example, if the fluid contained in the pipe bore between the first plug assembly and the second plug assembly has a density which is less than that of the wellbore fluid, the fluid contained in the pipe bore between the third plug assembly and the first plug assembly may have a density which is equal to or greater than that of the wellbore fluid. As a non-limiting example, the fluid which is contained in the pipe bore between the third plug assembly and the first plug assembly may be a delivery fluid. As a non-limiting example, the delivery fluid may comprise, consist of, or consist essentially of a wellbore fluid.

In the method of the third aspect, unsealing the first plug assembly and the second plug assembly may be performed in any suitable manner, and may be performed in any suitable order. In some embodiments of the third aspect in which the first plug assembly comprises a first sleeve defining a first primary channel and a first plug blocking the first primary channel, unsealing the first plug assembly may comprise unblocking the first primary channel. In some embodiments of the third aspect in which the second plug assembly comprises a second sleeve defining a second primary channel and a second plug blocking the second primary channel, unsealing the second plug assembly may comprise unblocking the second primary channel.

In some embodiments of the third aspect, the method may comprise introducing a delivery fluid into the pipe bore proximal to the first plug assembly. The delivery fluid may be introduced into the pipe bore in any suitable manner and at any suitable time. In some embodiments of the third aspect, the delivery fluid may comprise, consist of, or consist essentially of a wellbore fluid. In some embodiments of the third aspect, the delivery fluid may be introduced into the pipe bore proximal to the first plug assembly before the pipe system is inserted into the wellbore. In some embodiments of the third aspect, the delivery fluid may be introduced into the pipe bore proximal to the first plug assembly while or after the pipe system is inserted into the wellbore.

In some embodiments of the third aspect in which the first plug assembly comprises a first sleeve defining a first primary channel and a first plug blocking the first primary channel, unsealing the first plug assembly and the second plug assembly may comprise unblocking the first primary channel, allowing the fluid to mix with the delivery fluid wherein the pipe bore to form a fluid mixture, unsealing the second plug assembly, and allowing the fluid mixture to drain through the second plug assembly, either in the order as listed or in some other suitable order.

In some embodiments of the third aspect in which the second plug assembly comprises a second sleeve defining a second primary channel and a second plug blocking the second primary channel, unsealing the first plug assembly and the second plug assembly may comprise unsealing the first plug assembly, allowing the fluid to mix with the delivery fluid within the pipe bore to form a fluid mixture, unblocking the second primary channel, and allowing the fluid mixture to drain through the second plug assembly, either in the order as listed or in some other suitable order.

In some embodiments of the third aspect in which the first plug assembly comprises a first sleeve defining a first primary channel and a first plug blocking the first primary channel and in which the second plug assembly comprises a second sleeve defining a second primary channel and a second plug blocking the second primary channel, unsealing the first plug assembly and the second plug assembly may comprise unblocking the first primary channel, allowing the fluid to mix with the delivery fluid within the pipe bore to form a fluid mixture, unblocking the second primary channel, and allowing the fluid mixture to drain through the second plug assembly, either in the order as listed or in some other suitable order.

In some embodiments of the method of the third aspect, unsealing the first plug assembly and/or unsealing the second plug assembly may comprise increasing a pressure within the pipe bore. In some embodiments of the third aspect, unsealing the first plug assembly may comprise applying a pressure, force or impact to a first plug and/or unsealing the second plug assembly may comprise applying a pressure, force or impact to a second plug.

In some embodiments of the second aspect and the third aspect in which the first plug assembly comprises a first sleeve defining a first primary channel and a first plug blocking the first primary channel and/or the second plug assembly comprises a second sleeve defining a second primary channel and a second plug blocking the second primary channel, the first primary channel cross-sectional area and/or the second primary channel cross-sectional area may be selected to control a rate of draining of the fluid mixture from the first plug assembly and/or the second plug assembly. In some particular embodiments of the second aspect and the third aspect, the second primary channel cross-sectional area may be selected to control a rate of draining of the fluid mixture from the second plug assembly.

In some embodiments of the method of the third aspect, the method may further comprise pumping the fluid mixture from the wellbore. The fluid mixture may be pumped from the wellbore as the fluid mixture drains from the pipe system or after the fluid mixture drains from the pipe system. The fluid mixture may be pumped from the wellbore in any suitable manner, and may be pumped to a distal end of the wellbore, to a surface end of the wellbore, or to some other location.

In some embodiments of the second aspect and the third aspect in which the first plug assembly comprises a first sleeve defining a first primary channel and a first plug blocking the first primary channel and/or the second plug assembly comprises a second sleeve defining a second primary channel and a second plug blocking the second primary channel, both the first sleeve and the second sleeve may be dissolvable in the presence of one or more disintegrating agents. In some embodiments of the second aspect and the third aspect, at least one of a first plug and a second plug may be dissolvable in the presence of one or more disintegrating agents.

In some embodiments of the method of the third aspect in which a first plug is dissolvable in the presence of a first plug disintegrating agent, the method may comprise allowing the first plug to dissolve in the presence of the first plug disintegrating agent.

In some embodiments of the method of the third aspect, the method may comprise allowing a first plug to dissolve in the presence of a first plug disintegrating agent before unblocking a first primary channel. In some embodiments of the method of the third aspect, the method may comprise allowing a first plug to dissolve in the presence of a first plug disintegrating agent after unblocking a first primary channel. In some embodiments of the method of the third aspect, the method may comprise allowing a first plug to dissolve in the presence of a first plug disintegrating agent after unblocking a first primary channel and before unblocking a second primary channel. In some embodiments of the method of the third aspect, the method may comprise allowing a first plug to dissolve in the presence of a first plug disintegrating agent after unblocking both a first primary channel and a second primary channel.

In some embodiments of the method of the third aspect in which a second plug is dissolvable in the presence of a second plug disintegrating agent, the method may comprise allowing the second plug to dissolve in the presence of the second plug disintegrating agent.

In some embodiments of the method of the third aspect, the method may comprise allowing a second plug to dissolve in the presence of a second plug disintegrating agent before unblocking a first primary channel. In some embodiments of the method of the third aspect, the method may comprise allowing a second plug to dissolve in the presence of a second plug disintegrating agent after unblocking a first primary channel. In some embodiments of the method of the third aspect, the method may comprise allowing a second plug to dissolve in the presence of a second plug disintegrating agent after unblocking a first primary channel and before unblocking a second primary channel. In some embodiments of the method of the third aspect, the method may comprise allowing a second plug to dissolve in the presence of a second plug disintegrating agent after unblocking both a first primary channel and a second primary channel.

In some embodiments of the method of the third aspect in which a first sleeve is dissolvable in the presence of a first sleeve disintegrating agent, the method may comprise allowing the first sleeve to dissolve in the presence of the first sleeve disintegrating agent.

In some embodiments of the method of the third aspect, the method may comprise allowing a first sleeve to dissolve in the presence of a first sleeve disintegrating agent before unblocking a first primary channel. In some embodiments of the method of the third aspect, the method may comprise allowing a first sleeve to dissolve in the presence of a first sleeve disintegrating agent after unblocking a first primary channel. In some embodiments of the method of the third aspect, the method may comprise allowing a first sleeve to dissolve in the presence of a first sleeve disintegrating agent after unblocking a first primary channel and before unblocking a second primary channel. In some embodiments of the method of the third aspect, the method may comprise allowing a first sleeve to dissolve in the presence of a first sleeve disintegrating agent after unblocking both a first primary channel and a second primary channel.

In some embodiments of the method of the third aspect in which a second sleeve is dissolvable in the presence of a second disintegrating agent, the method may comprise allowing the second sleeve to dissolve in the presence of the second sleeve disintegrating agent.

In some embodiments of the method of the third aspect, the method may comprise allowing a second sleeve to dissolve in the presence of a second sleeve disintegrating agent before unblocking a first primary channel. In some embodiments of the method of the third aspect, the method may comprise allowing a second sleeve to dissolve in the presence of a second sleeve disintegrating agent after unblocking a first primary channel. In some embodiments of the method of the third aspect, the method may comprise allowing a second sleeve to dissolve in the presence of a second sleeve disintegrating agent after unblocking a first primary channel and before unblocking a second primary channel. In some embodiments of the method of the third aspect, the method may comprise allowing a second sleeve to dissolve in the presence of a second sleeve disintegrating agent after unblocking both a first primary channel and a second primary channel.

In some embodiments of the method of the third aspect, the method may comprise allowing one or more components of the first plug assembly and/or the second plug assembly in addition to or in substitution for a sleeve and/or a plug to dissolve in the presence of one or more disintegrating agents. As a non-limiting example, in some embodiments of the method of the third aspect, the method may comprise allowing a retaining device to dissolve in the presence of a retaining device disintegrating agent. As a non-limiting example, in some embodiments of the method of the third aspect, the method may comprise allowing a stop to dissolve in the presence of a stop disintegrating agent.

In some embodiments of the method of the third aspect, the method may comprise pumping one or more of the non-dissolvable components of the first plug assembly and the second plug assembly out of the pipe bore after unblocking the first primary channel and the second primary channel. The non-dissolvable components of the first plug assembly and the second plug assembly may be pumped out of the pipe bore in any suitable manner, and may be pumped to a distal end of the wellbore, to a surface end of the wellbore or to some other location.

In some embodiments of the method of the third aspect, the pipe system may comprise one or more additional plug assemblies in addition to the first plug assembly and the second plug assembly. In some particular embodiments of the method of the third aspect, the pipe system may further comprise a third plug assembly sealing the pipe bore. In such particular embodiments, the third plug assembly may be separated from the first plug assembly by a distance within the pipe bore, such that the third plug assembly is proximal to the first plug assembly. In some such particular embodiments, the third plug assembly may be similar or identical to the plug assembly of the first aspect or to one or both of the plug assemblies of the second and third aspects.

In some such embodiments of the method of the third aspect, the method may comprise sealing a fluid within the pipe bore between the fluid plug assembly and the first plug assembly. In some such embodiments of the method of the third aspect, the method may comprise unsealing the third plug assembly. In some such embodiments of the method of the third aspect, the fluid may be less dense than a wellbore fluid which is likely to be contained in the wellbore.

In some such embodiments of the method of the third aspect, the third plug assembly may comprise a third sleeve which defines a third primary channel and a third plug blocking the third primary channel, the third primary channel may have a third primary channel cross-sectional area, and the third primary cross-sectional area may be greater than 50 percent of the bore cross-sectional area. In some such embodiments of the method of the third aspect, unsealing the third plug assembly may comprise unblocking the third primary channel. In some such embodiments of the method of the third aspect, the method may comprise allowing the third sleeve to dissolve in the presence of a third sleeve disintegrating agent. In some such embodiments of the method of the third aspect, the third plug may be dissolvable in the presence of a third plug disintegrating agent, and the method may comprise allowing the third plug to dissolve in the presence of the third plug disintegrating agent. In some such embodiments of the method of the third aspect, the method may comprise allowing one or more components of the third plug assembly in addition to or in substitution for the third sleeve and/or the third plug to dissolve in the presence of one or more disintegrating agents, including as non-limiting examples, a retaining device and/or a stop.

### BRIEF DESCRIPTION OF DRAWINGS

Embodiments of the invention will now be described with reference to the accompanying drawings, in which:

FIG. 1 is a longitudinal cross-sectional view of a first exemplary embodiment of a plug assembly within a pipe bore of a pipe.

FIG. 2 is a longitudinal cross-sectional view of a second exemplary embodiment of a plug assembly within a pipe bore of a pipe.

FIG. 3 is a transverse section view of the first exemplary embodiment of the plug assembly depicted in FIG. 1, taken along line 3-3 of FIG. 1.

FIG. 4 is a transverse section view of the second exemplary embodiment of the plug assembly depicted in FIG. 2, taken along line 4-4 of FIG. 2.

FIG. 5 is a cross-sectional view of an isolated section of a first exemplary embodiment of a pipe system comprising a first plug assembly and a second plug assembly, wherein the second plug assembly is distal to the first plug assembly, wherein the first plug assembly is the first exemplary embodiment depicted in FIGS. 1 and 3, and wherein the second plug assembly is the second exemplary embodiment depicted in FIGS. 2 and 4.

FIG. 6 is a transverse section view of the first plug assembly in the first exemplary embodiment of the pipe system depicted in FIG. 5, taken along line 6-6 of FIG. 5.

FIG. 7 is a transverse section view of the second plug assembly in the first exemplary embodiment of the pipe system depicted in FIG. 5, taken along line 7-7 of FIG. 5.

FIG. 8 is a cross-sectional view of an isolated section of a second exemplary embodiment of a pipe system comprising a first plug assembly and a second plug assembly, wherein the second plug assembly is distal to the first plug assembly, wherein the first plug assembly is the first exemplary embodiment depicted in FIGS. 1 and 3, and wherein the second plug assembly does not comprise a second sleeve, but comprises a second plug.

FIG. 9 is a transverse section view of the first plug assembly in the second exemplary embodiment of the pipe system depicted in FIG. 5, taken along line 9-9 of FIG. 8.

FIG. 10 is a transverse section view of the second plug assembly in the second exemplary embodiment of the pipe system depicted in FIG. 5, taken along line 10-10 of FIG. 8.

FIG. 11 is a schematic view of the first exemplary embodiment of the pipe system of FIGS. 5-7 or the second exemplary embodiment of the pipe system of FIGS. 8-10, positioned within an exemplary wellbore.

### DETAILED DESCRIPTION

In the description which follows, features which are identical, similar or equivalent in the described exemplary embodiments may be identified by the same reference number.

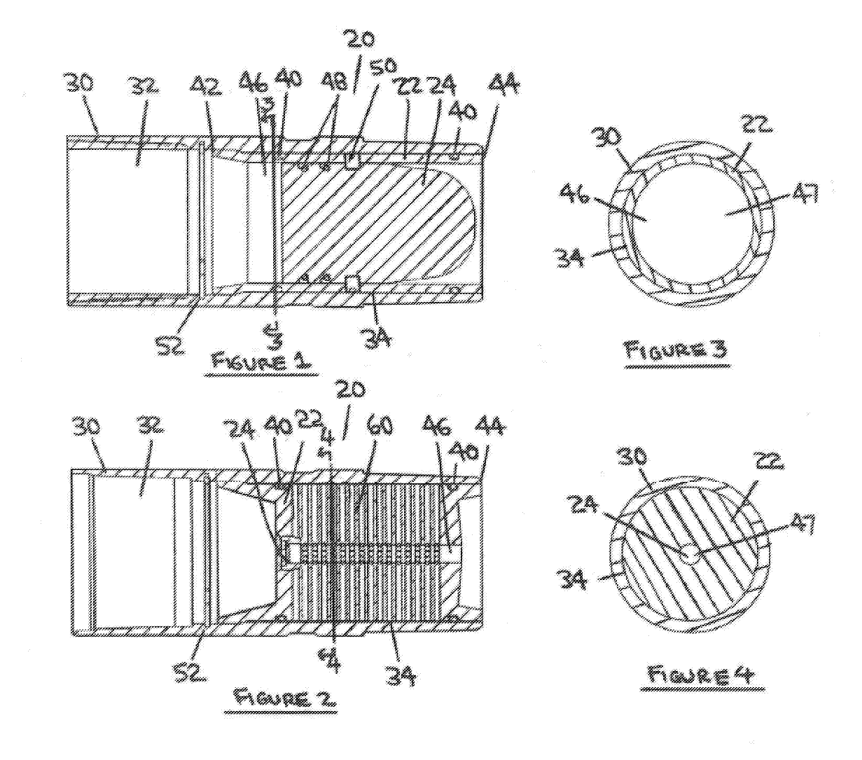

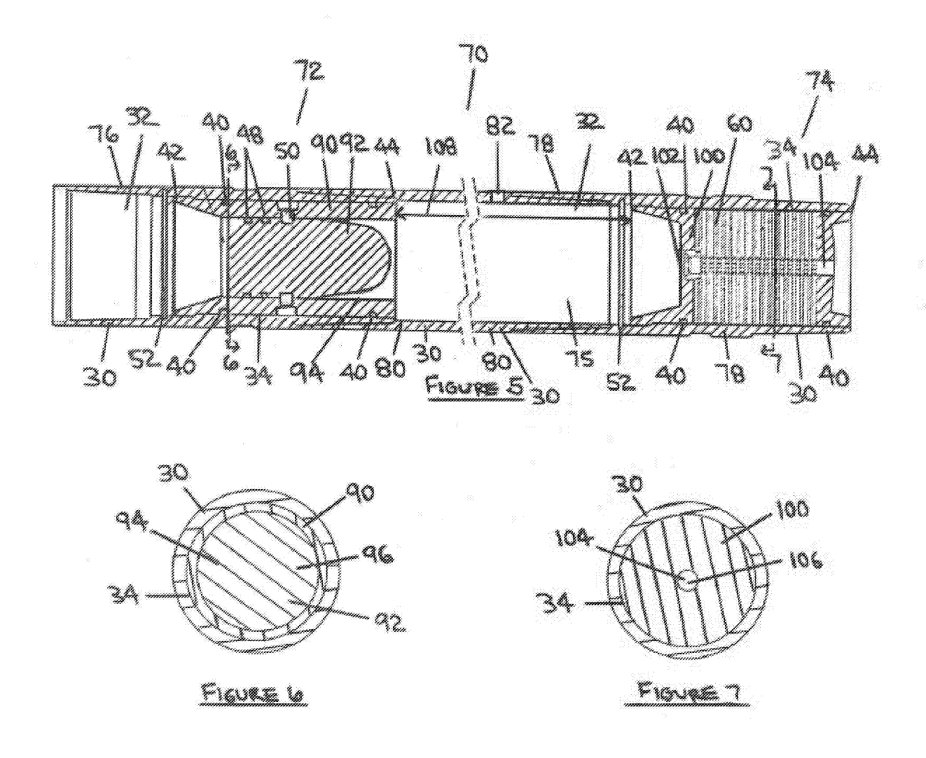

Referring to FIGS. 1 and 3, a first exemplary embodiment of a plug assembly (20) is depicted.

The plug assembly (20) comprises a sleeve (22) and a plug (24).

The plug assembly (20) is configured for use with a pipe (30) defining a pipe bore (32). More particularly, the plug assembly (20) is configured for sealing the pipe bore (32) of the pipe (30). The pipe bore (32) has a bore cross-sectional area. The bore-cross-sectional area is defined and bounded by an inner circumference (34) of the pipe (32).

In the first exemplary embodiment of the plug assembly (20), the pipe (30) is generally cylindrical and defines a generally circular pipe bore (32). In other embodiments, the pipe (30) may have other shapes and may define pipe bores (32) having other shapes.

In the first exemplary embodiment of the plug assembly (20), the sleeve (22) is sized and configured for positioning within the pipe bore (32) such that a seal is provided between the sleeve (22) and the pipe (30). The seal between the sleeve (22) and the pipe (30) may be provided in any manner. In the first exemplary embodiment of the plug assembly (20), the sleeve (22) is configured to fit closely within the pipe bore (32) and the seal between the sleeve (22) and the pipe (30) is provided or enhanced in the plug assembly (20) by two seal elements (40) such as O-ring seals which extend circumferentially around the sleeve (22).

The sleeve (22) has a proximal end (42) and a distal end (44), and defines a primary channel (46) extending through the sleeve (22) from the proximal end (42) to the distal end (44).

In the first exemplary embodiment of the plug assembly (20), the sleeve (22) is a dissolvable sleeve (22) which is dissolvable in the presence of a sleeve disintegrating agent. More particularly, in the first exemplary embodiment of the plug assembly (20), the sleeve (22) is constructed entirely from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a sleeve disintegrating agent, which may be contained in a delivery fluid. As a non-limiting example, the delivery fluid may comprise, consist of, or consist essentially of a wellbore fluid.

The primary channel (46) has a primary channel cross-sectional area (47). In the first exemplary embodiment of the plug assembly (20), the primary channel cross-sectional area (47) of the primary channel (46) is greater than 50 percent of the bore cross-sectional area of the pipe bone (32).

The plug (24) blocks the primary channel (46) of the sleeve (22). In the first exemplary embodiment of the plug assembly (20), the plug (24) is configured to fit within the primary channel (46) in order to block the primary channel (46). In the first exemplary embodiment of the plug assembly (20), the plug (24) fits within the primary channel (46) such that a seal is provided between the plug (24) and the primary channel (46). More particularly, in the first exemplary embodiment of the plug assembly (20), the plug (24) is configured to fit closely within the primary channel and the seal between the plug (34) and the primary channel (46) is provided or enhanced in the plug assembly (20) by two seal elements (48) such as O-ring seals which extend circumferentially around the plug (24).

In the first exemplary embodiment of the plug assembly (20), the plug (24) is releasable from the primary channel (46) in order to unblock the primary channel (46). In the first exemplary embodiment of the plug assembly (20), the plug assembly (20) comprises a retaining device (50) for retaining the plug (24) within the primary channel (46). In the first exemplary embodiment of the plug assembly (20), the retaining device (50) comprises two shear pins which are received within recesses in both the sleeve (22) and the plug (24) and which connect the plug (24) with the sleeve (22) in order to releasably retain the plug (24) within the primary channel (46).

In the first exemplary embodiment of the plug assembly (20), the shear pins may be broken in order to release the plug (24) from the primary channel (46). The shear pins may be broken by increasing a pressure within the pipe bore (32) and/or by applying a force or impact to the plug (24).

In the first exemplary embodiment of the plug assembly (20), the shear pins are constructed of a suitable metal, such as steel. In other embodiments, the retaining device (50) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a retaining device disintegrating agent, which may be contained in a delivery fluid. As a non-limiting example, the delivery fluid may comprise, consist of, or consist essentially of a wellbore fluid.

In the first exemplary embodiment of the plug assembly (20), the plug (24) is constructed of a suitable metal such as steel. In other embodiments, the plug (24) may be constructed in whole or in part from a dissolvable material. As non-limiting examples, the dissolvable material may comprise, consist of, or consist essentially of a dissolvable magnesium alley such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a plug disintegrating agent, which may be contained in a delivery fluid. As a non-limiting example, the delivery fluid may comprise, consist of, or consist essentially of a wellbore fluid.

In the first exemplary embodiment of the plug assembly (20), the plug assembly (20) comprises a stop (52) for resisting movement of the sleeve (22) in a proximal or uphole direction relative to the pipe (30), which may otherwise be caused by buoyancy or other forces acting on the sleeve (22) and/or the plug (24) in a proximal direction. In the first exemplary embodiment of the plug assembly (20), the stop (52) comprises a retaining ring which is received within a groove in the interior surface of the pipe (30) and which extends into the pipe bore (32).

In the first exemplary embodiment of the plug assembly (20), the stop (52) is constructed of a suitable metal such as steel. In other embodiments, the stop (52) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a stop disintegrating agent, which may be contained in a delivery fluid. As a non-limiting example, the delivery fluid may comprise, consist of, or consist essentially of a wellbore fluid.

Referring to FIGS. 2 and 4, a second exemplary embodiment of a plug assembly (20) is depicted.

The description of the second exemplary embodiment of the plug assembly (20) which follows is limited to those features of the second exemplary embodiment which are additional to or different from the features of the first exemplary embodiment of the plug assembly (20) which have previously been described.

In the second exemplary embodiment of the plug assembly (20), the primary channel cross-sectional area (47) of the primary channel (46) is less than 50 percent of the bore cross-sectional area of the pipe bore (32).

In the second exemplary embodiment of the plug assembly (20), the sleeve (22) is shaped to enhance a rate at which the sleeve (22) dissolves. More particularly, in the second exemplary embodiment of the plug assembly (20), the sleeve (22) is shaped so that it defines a plurality of secondary channels (60). In the second exemplary embodiment of the plug assembly (20), the secondary channels (60) are in communication with the primary channel (46) between the proximal end (42) and the distal end (44) of the sleeve (22) and extend radially through the sleeve (22) from the primary channel (46). In the second exemplary embodiment of the plug assembly (20), the secondary channels (60) are substantially equally spaced radially around the circumference of the primary channel (46).

In the second exemplary embodiment of the plug assembly (20), the plug (24) covers a proximal end of the primary channel (46) in order to block the primary channel (46). In the second exemplary embodiment of the plug assembly (20), the plug (24) blocks the primary channel (46) proximal to the secondary channels (60).

In the second exemplary embodiment of the plug assembly (20), the plug (24) is breakable in order to unblock the primary channel (46). More particularly, in the second exemplary embodiment of the plug assembly (20), the plug (24) comprises a burst plug which is breakable by increasing a pressure within the pipe bore (32) and/or by applying a force or impact to the burst plug. As a result, in the second exemplary embodiment of the plug assembly (20), the seal elements (48) on the plug (24) and the retaining device (50) of the first exemplary embodiment of the plug assembly (20) are not required in the second exemplary embodiment of the plug assembly (20).

In the second exemplary embodiment of the plug assembly (20), the burst plug is constructed of a suitable metal such as steel. In other embodiments, the plug (24) may be constructed in whole or in part from a dissolvable material. As non-limiting examples, the dissolvable material may comprise, consist of, or consist essentially of a dissolvable magnesium alley such as a SoluMag™ dissoluble magnesium alloy manufactured by Magnesium Elektron or a TervAlloy™ dissolvable magnesium, alloy manufactured by Terves Inc. As non-limiting examples, the dissolvable material may dissolve in the presence of an acid, a salt, and/or fresh water as a plug disintegrating agent, which may be contained in a delivery fluid. As a non-limiting example, the delivery fluid may comprise, consist of, or consist essentially of a wellbore fluid.

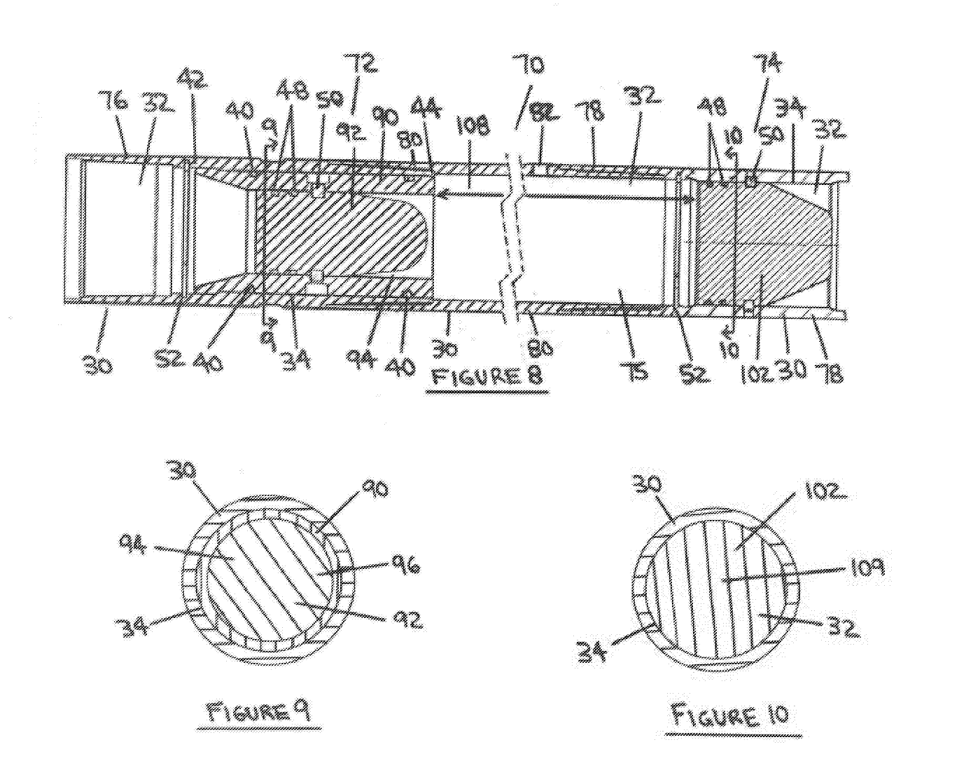

Referring to FIGS. 5-7, an isolated section of a first exemplary embodiment of a pipe system (70) is depicted. In the first exemplary embodiment of the pipe system (70), the pipe system (70) is configured to be inserted into a wellbore (not shown in FIGS. 5-7).

In the first exemplary embodiment of the pipe system (70), the pipe system (70) comprises a pipe (30) defining a pipe bore (32), a first plug assembly (72), a second plug assembly (74), and a fluid (75) contained within the pipe bore (32) between the first plug assembly (72) and the second plug assembly (74).

In the first exemplary embodiment of the pipe system (70), the pipe (30) is a tubing string which comprises lengths of tubing which are connected together with threaded connections. In other embodiments, the pipe (30) may be a casing, a liner, and/or any other type of pipe, which may be provided as connected lengths of pipe (30) or as a continuous pipe (30). In the first exemplary embodiment of the pipe system (70), the pipe (30) is generally cylindrical and defines a generally circular pipe bore (32). The pipe bore has a bore cross-sectional area.

As depicted in FIG. 5, the first plug assembly (72) is positioned within the pipe bore (32) of a proximal length (76) of the pipe (30), the second plug assembly (74) is positioned within the pipe bore (32) of a distal length (78) of the pipe (30), and a number of intermediate lengths (80) of the pipe (30) are interconnected between the proximal length (76) of the pipe (30) and the distal length (78) of the pipe (30). Additional lengths (not shown in FIG. 5) of the pipe (30) may be connected with the proximal end of the proximal length (76) of the pipe (30) and/or optionally with the distal end of the distal length (78) of the pipe (30).

In the first exemplary embodiment of the pipe system (70), one or more intermediate lengths (80) of the pipe (30) may optionally be provided with a sealable port (82) for enabling the fluid (75) to be introduced into the pipe bore (32) between the first plug assembly (72) and the second plug assembly (74).

In the first exemplary embodiment of the pipe system (70), the first plug assembly (72) is substantially identical to the first exemplary embodiment of the plug assembly (20) which is depicted in FIGS. 1 and 3 and which has previously been described.

The first plug assembly (72) seals the pipe bore (32). In the first exemplary embodiment of the pipe system (70), the first plug assembly (72) comprises a first sleeve (90) and a first plug (92).

In the first exemplary embodiment of the pipe system (70), the first sleeve (90) is positioned within the pipe bore (32) such that a seal is provided between the first sleeve (90) and the pipe (30). In the first exemplary embodiment of the pipe system (70), the first sleeve (90) is configured to fit closely within the pipe bone (32) and the seal between the first sleeve (90) and the pipe (30) is provided or enhanced in the first plug assembly (72) by two seal elements (40) such as O-ring seals which extend circumferentially around the first sleeve (90).

The first sleeve (90) has a proximal end (42) and a distal end (44), and defines a first primary channel (94) extending through the first sleeve (90) from the proximal end (42) to the distal end (44).

In the first exemplary embodiment of the pipe system (70), the first sleeve (90) is a dissolvable first sleeve (90) constructed entirely from a dissolvable material. As non-limiting examples, the dissolvable material may comprise, consist of, or consist essentially of a dissolvable magnesium alloy such as a SoluMag™ dissolvable magnesium alloy manufactured by Magnesium Electron or a TervAlloy™ dissolvable magnesium alloy manufactured by Terves Inc. As non-limiting examples, the dissolvable material may dissolve in the presence of an acid, a salt, and/or fresh water as a first sleeve disintegrating agent, which may be contained in a delivery fluid. As a non-limiting example, the delivery fluid may comprise, consist of, or consist essentially of a wellbore fluid.

The first primary channel (94) has a first primary channel cross-sectional area (96). In the first exemplary embodiment of the pipe system (70), the first primary channel cross-sectional area (96) of the first primary channel (94) is greater than 50 percent of the bore cross-sectional area of the pipe bore (32).

The first plug blocks the first primary channel (94) of the first sleeve (90). In the first exemplary embodiment of the pipe system (70), the first plug (92) is configured to fit within the first primary channel (94) in order to block the first primary channel (94). In the first exemplary embodiment of the pipe system (70), the first plug (92) fits within the first primary channel (94) such that a seal is provided between the first plug (92) and the first primary channel (94). More particularly, in the first exemplary embodiment of the pipe system (70), the first plug (92) is configured to fit closely within the first primary channel (94) and the seal between the first plug (32) and the first primary channel (94) is provided or enhanced in the first plug assembly (72) by two seal elements (48) such as O-ring seals which extend circumferentially around the first plug (92).

In the first exemplary embodiment of the pipe system (70), the first plug (92) is releasable from the first primary (94) in order to unblock the first primary channel (94). In the first exemplary embodiment of the pipe system (70), the first plug assembly (72) comprises a retaining device (50) for retaining the first plug (92) within the first primary channel (94). In the first exemplary embodiment of the pipe system (70), the retaining device (50) comprises two shear pins which are received within recesses in both the first sleeve (90) and the first plug (92) and which connect the list plug (92) with the list sleeve (90) in order to releasably retain the first plug (92) within the first primary channel (94).

In the first exemplary embodiment of the pipe system (70), the shear pins may be broken in order to release the first plug (92) from the first primary channel (94). The shear pins may be broken by increasing a pressure within the pipe bore (32) and/or by applying a force or impact to the first plug (92).

In the first exemplary embodiment of the pipe system (70), the shear pins are constructed of a suitable metal, such as steel. In other embodiments, the retaining device (50) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fish water as a retaining device disintegrating agent, which may be contained in a delivery fluid. As a non-limiting example, the delivery fluid may comprise, consist of, or consist essentially of a wellbore fluid.

In the first exemplary embodiment of the pipe system (70), the first plug (92) is constructed of a suitable metal such as steel. In other embodiments, the first plug (92) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a first plug disintegrating agent, which may be contained in a delivery fluid. As a non-limiting example, the delivery fluid may comprise, consist of, or consist essentially of a wellbore fluid.

In the first exemplary embodiment of the pipe system (70), the first plug assembly (72) comprises a stop (52) for resisting movement of the first sleeve (90) in a proximal or uphole direction relative to the pipe (30), which may otherwise be caused by buoyancy or other forces acting on the first sleeve (90) and/or the first plug (92) in a proximal direction. In the first exemplary embodiment of the pipe system (70), the stop (52) comprises a retaining ring which is received within a groove in the interior surface of the pipe (30) and which extends into the pipe bore (32).

In the first exemplary embodiment of the pipe system (70), the stop (52) is constructed of a suitable metal such as steel. In other embodiments, the stop (52) may be constructed in whole or in part from a dissolvable material. As non-limiting examples, the dissolvable material may comprise, consist of, or consist essentially of a dissolvable magnesium alloy such, as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a stop disintegrating agent, which may be contained in a delivery fluid. As a non-limiting example, the delivery fluid may comprise, consist of, or consist essentially of a wellbore fluid.

In the first exemplary embodiment of the pipe system (70), the second plug assembly (74) is substantially identical to the second exemplary embodiment of the plug assembly (20) which is depicted in FIGS. 2 and 4 and which has previously been described.

The second plug assembly (74) seals the pipe bore (32). In the first exemplary embodiment of the pipe system (70), the second plug assembly (74) comprises a second sleeve (100) and a second plug (102).

In the first exemplary embodiment of the pipe system (70), the second sleeve (100) is positioned within the pipe bore (32) such that a seal is provided between the second sleeve (100) and the pipe (30). In the first exemplary embodiment of the pipe system (70), the second sleeve (100) is configured to fit closely within the pipe bore (32) and the seal between the second sleeve (100) and the pipe (30) is provided or enhanced in the second plug assembly (74) by two seal elements (40) such as O-ring seals which extend circumferentially around the second sleeve (100).

The second sleeve (100) has a proximal end (42) and a distal end (44), and defines a second primary channel (104) extending through the second sleeve (100) from the proximal and (42) to the distal end (44).

In the first exemplary embodiment of the pipe system (70), the second sleeve (100) is a dissolvable second sleeve (100) constructed entirely from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a second sleeve disintegrating agent, which may be contained in a delivery fluid. As a non-limiting example, the delivery fluid may comprise, consist of, or consist essentially of a wellbore fluid.

The second primary channel (104) has a second primary channel cross-sectional area (106). In the first exemplary embodiment of the pipe system (70), the second primary channel cross-sectional area (106) of the second primary channel (104) is less than 50 percent of the bore cross-sectional area of the pipe bore (32).

In the first exemplary embodiment of the pipe system (70), the second sleeve (100) is shaped to enhance a rate at which the second sleeve (100) dissolves. More particularly, in the first exemplary embodiment of the pipe system (70), the second sleeve (100) is shaped so that it defines a plurality of secondary channels (60). In the first exemplary embodiment of the pipe system (70), the secondary channels (60) are in communication with the second primary channel (104) between the proximal end (42) and the distal end (44) of the second sleeve (100) and extend radially through the second sleeve (100) from the second primary channel (104). In the first exemplary embodiment of the pipe system (70), the secondary channels (60) ace substantially equally spaced radially around the circumference of the second primary channel (104).

The second plug (102) blocks the second primary channel (104) of the second sleeve (100). In the first exemplary embodiment of the pipe system, the second plug (102) covers a proximal end of the second primary channel (104) in order to block the second primary channel (104). In the first exemplary embodiment of the pipe system (70), the second plug (102) blocks the second primary channel (104) proximal to the secondary channels (60).

In the first exemplary embodiment of the pipe system (70), the second plug (102) is breakable in order to unblock the second primary channel (104). More particularly, in the first exemplary embodiment of the pipe system (70), the second plug (102) comprises a burst plug which is breakable by increasing a pressure within the pipe bore (32) and/or by applying a force or impact to the burst plug. As a result, in the first exemplary embodiment of the pipe system (70), the second plug (102) does not require the seal elements (48) or the retaining device (50) which are provided for the first plug assembly (72).

In the first exemplary embodiment of the pipe system (70), the burst plug is constructed of a suitable metal such as steel. In other embodiments, the second plug (102) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh wafer as a second plug disintegrating agent, which may be contained in a delivery fluid. As a non-limiting example, the delivery fluid may comprise, consist of, or consist essentially of a wellbore fluid.

In the first exemplary embodiment of the pipe system (70), the second plug assembly (74) comprises a stop (52) for resisting movement of the second sleeve (100) in a proximal or uphole direction relative to the pipe (30), which may otherwise be caused by buoyancy or other forces acting on the second sleeve (100) and/or the second plug (102) in a proximal direction. In the first exemplary embodiment of the pipe system (70), the stop (52) comprises a retaining ring which is received within a groove in the interior surface of the pipe (30) and which extends into the pipe bore (32).

In the first exemplary embodiment of the pipe system (70), the stop (52) is constructed of a suitable metal such as steel. In other embodiments, the stop (52) may be constructed in whole or in part from a dissolvable material. As non-limiting examples, the dissolvable material may comprise, consist of, or consist essentially of a dissolvable, magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a stop disintegrating agent, which may be contained in a delivery fluid. As a non-limiting example, the delivery fluid may comprise, consist of, or consist essentially of a wellbore fluid.

The first plug assembly (72) and the second plug assembly (74) are separated by a distance (108) within the pipe bore (32). In the first exemplary embodiment of the pipe system (70), the distance (108) between the first plug assembly (72) and the second plug assembly (74) may be determined by the number of intermediate lengths (80) of the pipe (30) which are interconnected between the proximal length (76) of the pipe (30) and the distal length (78) of the pipe (30). The distance (108) between the first plug assembly (72) and the second plug assembly (74) may be selected at least in part having regard to the conditions which are likely to be encountered by the pipe system (70) when it is inserted into the wellbore, including as a non-limiting example, the desired amount of increased buoyancy or reduced buoyancy which is sought to be achieved with the fluid (75).

In the first exemplary embodiment of the pipe system (70), the fluid (75) which is contained within the pipe bore (32) between the first plug assembly (72) and the second plug assembly (74) may be selected at least in part having regard to the conditions which are likely to be encountered by the pipe system (70) when it is inserted within the wellbore (not shown in FIGS. 5-7).

If the pipe system (70) is likely to encounter frictional forces which resist the insertion of the pipe system (70) into the wellbore, the fluid (75) may be selected to be less dense than a wellbore fluid (not shown in FIGS. 5-7) which is likely to be contained in the wellbore and/or the distance (108) between the first plug assembly (72) and the second plug assembly (74) may be selected to cause the pipe system (70) to be more buoyant in the wellbore and thereby reduce the frictional force. Such frictional forces may be particularly problematic in deviated wellbores in which the pipe system (70) may tend to rest upon a low side of the wellbore.

If the pipe system (70) is likely to encounter buoyancy forces in the wellbore which resist the insertion of the pipe system (70) into the wellbore, the fluid (75) may be selected to be more dense than a wellbore fluid (not shown in FIGS. 5-7) which is likely to be contained in the wellbore and/or the distance (108) between the first plug assembly (72) and the second plug assembly (74) may be selected to cause the pipe system (70) to be less buoyant in the wellbore and thereby reduce the buoyancy forces. Such buoyancy forces may be particularly problematic in vertical wellbores in which the buoyancy forces directly oppose the forces applied to insert the pipe system (70) into the wellbore.

In the first exemplary embodiment of the pipe system (70), the pipe system (70) is configured to be inserted into a deviated wellbore. As a result, in the first exemplary embodiment of the pipe system (70), the fluid (75) which is contained in the pipe bore (32) between the first plug assembly (72) and the second plug assembly (74) is selected to be less dense than a wellbore fluid (not shown in FIGS. 5-7) which is likely to be contained in the wellbore (110), and the distance (108) between the first plug assembly (72) and the second plug assembly (74) is selected to optimize the buoyancy of the pipe system (70). In the first exemplary embodiment of the pipe system (70), the fluid (75) comprises, consists of, or consists essentially of a substance or a combination of substances which is substantially in a gas phase under the conditions likely to be encountered in the wellbore, such as air and/or an inert gas.

In the first exemplary embodiment of the pipe system (70), it may be desirable to maximize the amount of increased buoyancy or reduced buoyancy which is achieved with the fluid (75). As a result, in the first exemplary embodiment of the pipe system (70), the first plug assembly (72) and the second plug assembly (74) may as non-limiting examples be separated by at least 100 meters, by at least 300 meters, by at least 500 meters, or by more than 500 meters.

In the first exemplary embodiment of the pipe system (70) as depicted in FIGS. 5-7, the pipe system (70) comprises the first plug assembly (72) and the second plug assembly (74). In variations of the first exemplary embodiment of the pipe system (70) or in other embodiments of the pipe system (70), the pipe system (70) may comprise one or more additional plug assemblies (not shown in FIGS. 5-7), which may be identical to, similar to, or different from the first exemplary embodiment of the plug assembly (20) or the second exemplary embodiment of the plug assembly (20). In such variations of the first exemplary of the pipe system (70) and/or in such other embodiments, a fluid may be contained in the pipe bore (32) between one or more pairs of adjacent plug assemblies, which fluid may be the same or different as the fluid (75) which is contained between the first plug assembly (72) and the second plug assembly (74).

In a particular variation of the first exemplary embodiment of the pipe system (70), the pipe system (70) may comprise a third plug assembly (not shown in FIGS. 5-7), which is separated from the first plug assembly (72) by a distance (not shown) within the pipe bore (32), and which is proximal to the first plug assembly (72). In this particular variation of the first exemplary embodiment of the pipe system (70), the third plug assembly may be similar or identical to one of the first plug assembly (72) or the second plug assembly (74), or may be different from the first plug assembly (72) and the second plug assembly (74).

In the variation of the first exemplary embodiment of the pipe system (70) which comprises a third plug assembly, a fluid may be contained within the pipe bore (32) between the third plug assembly and the first plug assembly (72), which may be the same as the fluid (75) which is contained within the pipe bore (32) between the first plug assembly (72) and the second plug assembly (74), or which may be a different fluid. In the variation of the first exemplary embodiment of the pipe system (70) which comprises a third plug assembly, the third plug assembly may be separated from the first plug assembly (72) by any suitable distance, such as by at least 100 meters, by at least 300 meters, by at least 500 meters, or by more than 500 meters.

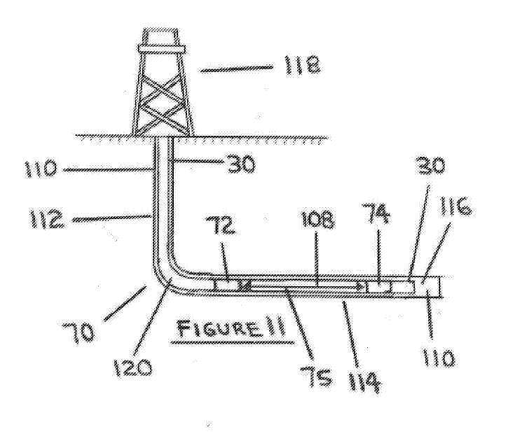

Referring to FIGS. 8-10, an isolated section of a second exemplary embodiment of a pipe system (70) is depicted. In the second exemplary embodiment of the pipe system (70), the pipe system (70) is configured to be inserted into a wellbore (not shown in FIGS. 8-10).

The description of the second exemplary embodiment of the pipe system (70) which follows is limited to those features of the second exemplary embodiment which are additional to or different from the feature; of the first exemplary embodiment of the pipe system (70) which have previously been described.

In the second exemplary embodiment of the pipe system (70), the first plug assembly (72) is substantially identical to the first exemplary embodiment of the plug assembly (20) which is depicted in FIGS. 1 and 3 and which has previously been described. In the second exemplary embodiment of the pipe system (70), the first plug assembly (72) is therefore also substantially identical to the first plug assembly (72) in the first exemplary embodiment of the pipe system (70).

In the second exemplary embodiment of the pipe system (70), the second plug assembly (74) does not comprise a second sleeve (therefore not shown in FIGS. 8-10), but comprises a second plug (102) which is positioned within the pipe bore (32) such that a seal is provided between the second plug (102) and the pipe (30).

In the second exemplary embodiment of the pipe system (70), the second plug (102) is therefore configured to fit within the pipe bore (32) in order to block the pipe bore (32). In the second exemplary embodiment of the pipe system (70), the second plug (102) fits within the pipe bore (32) such that a seal is provided between the second plug (102) and the pipe bore (32). More particularly, in the second exemplary embodiment of the pipe system (70), the second plug (102) is configured to fit closely within the pipe bore (32) and the seal between the second plug (102) and the pipe bore (32) is provided or enhanced in the second plug assembly (74) by two seal elements (48) such as O-ring seals which extend circumferentially around the second plug (102).

As a result, in the second exemplary embodiment of the pipe system (70), the second plug (102) has a second plug cross-sectional area (109) which is substantially equal to the bore cross-sectional area, so that the second plug cross-sectional area (109) is greater than 50 percent of the bore cross-sectional area.

In the second exemplary embodiment of the pipe system (70), the second plug 102 is releasable from the pipe bore (32) in order to unseal the second plug assembly (74). In the second, exemplary embodiment of the pipe system (70), the second plug assembly (74) comprises a retaining device (50) for retaining the second plug (102) within the pipe bore (32). In the second exemplary embodiment of the pipe system (70), the retaining device (50) comprises two shear pins which are received within recesses in both the distal length (7S) of the pipe (30) and the second plug (102) and which connect the second plug (102) with the distal length (78) of the pipe (301) in order to releasably retain the second plug (102) within the pipe bore (32).

In the second exemplary embodiment of the pipe system (70), the shear pins may be broken in order to release the second plug (102) from the pipe bore (32). The shear pins may be broken by increasing a pressure within the pipe bore (32) and/or by applying a force or impact to the second plug (102).

In the second exemplary embodiment of the pipe system (70), the shear pins are constructed of a suitable metal, such as steel. In other embodiments, the retaining device (50) may be constructed in whole or in part from a dissolvable material. As non-limiting examples, the dissolvable material may comprises, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a retaining device disintegrating agent, which may be contained in a delivery fluid. As a non-limiting example, the delivery fluid may comprise, consist of, or consist essentially of a wellbore fluid.

In the second exemplary embodiment of the pipe system (70), the second plug (102) is constructed of a suitable metal such as steel. In other embodiments, the second plug (102) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a second plug disintegrating agent, which may be contained in a delivery fluid. As a non-limiting example, the delivery fluid may comprise, consist of, or consist essentially of a wellbore fluid.

In the second exemplary embodiment of the pipe system (70), the second plug assembly (74) comprises a stop (52) for resisting movement of the second plug (102) in a proximal or uphole direction relative to the pipe (30), which may otherwise be caused by buoyancy or other forces acting on the second plug (102) in a proximal direction to the second exemplary embodiment of the pipe system (70), the stop (52) comprises a retaining ring which is received within a groove in the interior surface of the pipe (30) and which extends into the pipe bore (32).

In the second exemplary embodiment of the pipe system (70), the stop (52) is constructed of a suitable metal such as steel. In other embodiments, the stop (52) may be constructed in whole or in part from a dissolvable material. As non-limiting examples, the dissolvable material may comprise, consist of, or consist essentially of a dissolvable magnesium alloy such as a SoluMag™ dissolvable magnesium alloy manufactured by Magnesium Elektron or a TervAlloy™ dissolvable magnesium alloy manufactured by Terves Inc. As non-limiting examples, the dissolvable material may dissolve in the presence of an acid, a salt, and/or fresh water as a stop disintegrating agent, which may be contained in a delivery fluid. As a non-limiting example, the delivery fluid may comprise, consist of, or consist essentially of a wellbore fluid.

The first plug assembly (72) and the second plug assembly (74) are separated by a distance (108) within the pipe bore (32). In the second exemplary embodiment of the pipe system (70), the distance (108) between the first plug assembly (72) and the second plug assembly (74) may be determined by the number of intermediate lengths (80) of the pipe (30) which are interconnected between the proximal length (76) of the pipe (30) and the distal length (78) of the pipe (30). The distance (108) between the first plug assembly (72) and the second plug assembly (74) may be selected at least in part having regard to the conditions which are likely to be encountered by the pipe system (70) when it is inserted into the wellbore, including as a non-limiting example, the desired amount of increased buoyancy or reduced buoyancy which is sought to be achieved with the fluid (75).

In the second exemplary embodiment of the pipe system (70), the fluid (75) which is contained within the pipe bore (32) between the first plug assembly (72) and the second plug assembly (74) may be selected at least in part having regard to the conditions which are likely to be encountered by the pipe system (70) when it is inserted within the wellbore (not shown in FIGS. 8-10).

If the pipe system (70) is likely to encounter frictional forces which resist the insertion of the pipe system (70) into the wellbore, the fluid (75) may be selected to be less dense than a wellbore fluid (not shown in FIGS. 8-10) which is likely to be contained in the wellbore and/or the distance (108) between the first plug assembly (72) and the second plug assembly (74) may be selected to cause the pipe system (70) to be more buoyant in the wellbore and thereby reduce the fractional force.

If the pipe system (70) is likely to encounter buoyancy forces in the wellbore which resist the insertion of the pipe system (70) into the wellbore, the fluid (75) may be selected to be more dense than a wellbore fluid (not shown in FIGS. 8-10) which is likely to be contained in the wellbore and/or the distance (108) between the first plug assembly (72) and the second plug assembly (74) may be selected to cause the pipe system (70) to be less buoyant in the wellbore and thereby reduce the buoyancy forces.

In the second exemplary embodiment of the pipe system (70), the pipe system (70) is configured to be inserted into a deviated wellbore. As a result, in the second exemplary embodiment of the pipe system (70), the fluid (75) which is contained in the pipe bore (32) between, the first plug assembly (72) and the second plug assembly (74) is selected to be less dense than a wellbore fluid (not shown in FIGS. 8-10) which is likely to be contained in the wellbore (110), and the distance (108) between the first plug assembly (72) and the second plug assembly (74) is selected to optimize the buoyancy of the pipe system (70). In the second exemplary embodiment of the pipe system (70), the fluid (75) comprises, consists of, or consists essentially of a substance or a combination of substances which is substantially in a gas phase under the conditions likely to be encountered in the wellbore, such as air and/or an inert gas.

In the second exemplary embodiment of the pips system (70), it may be desirable to maximize the amount of increased buoyancy or reduced buoyancy which is achieved with the fluid (75). As a result, in the second exemplary embodiment of the pipe system (70), the first plug assembly (72) and the second plug assembly (74) may as non-limiting examples be separated by at least 100 meters, by at least 300 meters, by at least 500 meters, or by more than 500 meters.

In variations of the second exemplary embodiment of the pipe system (70) or in other embodiments of the pipe system (70), the pipe system (70) may comprise one or more additional plug assemblies (not shown in FIGS. 8-10), which may be identical to, similar to, or different from the first exemplary embodiment of the plug assembly (20) or the second exemplary embodiment of the plug assembly (20). In such variations of the second exemplary embodiment of the pipe system (70) and/or in such otter embodiments, a fluid may be contained in the pipe bore (32) between one or more pairs of adjacent plug assemblies, which fluid may be the same or different as the fluid (75) which is contained between the first plug assembly (72) and the second plug assembly (74).

In a particular variation of the second exemplary embodiment of the pipe system (70), the pipe system (70) may comprise a third plug assembly (not shown in. FIGS. 8-10), which is separate from the first plug assembly (72) by a distance (not shown) within the pipe bore (32), and which is proximal to the first plug assembly (72). In this particular variation of the second exemplary embodiment of the pipe system (70), the third plug assembly may be similar or identical to one of the first plug assembly (72) or the second plug assembly (74), or may be different from the first plug assembly (72) and the second plug assembly (74).

In the variation of the second exemplary embodiment of the pipe system (70) which comprises a third plug assembly, a fluid may be contained within the pipe bore (32) between the third plug assembly and the first plug assembly (72), which may be the same as the fluid (75) which is contained within the pipe bore (32) between the first plug assembly (72) and the second plug assembly (74), or which may be a different fluid. In the variation of the second exemplary embodiment of the pipe system (70) which comprises a third plug assembly, the third plug assembly may be separated from the first plug assembly (72) by any suitable distance, such as by at least 100 meters, by at least 300 meters, by at least 500 meters, or by more than 500 meters.

An exemplary method of inserting a pipe system (70) into a wellbore (110) is now described with reference to FIGS. 5-11.

Referring to FIG. 11, in the exemplary method, the wellbore (110) is a deviated wellbore having a substantially vertical section (112) extending from a surface or proximal end of the wellbore (110) and a deviated section (114) extending from a distal end of the vertical section (112) to a distal end of the wellbore (110). The wellbore (110) is adapted to contain a wellbore fluid (116). The wellbore fluid (116) may be present in the wellbore (110) before the pipe system (70) is inserted into the wellbore (110), or the wellbore fluid (116) may be introduced into or may enter the wellbore (110) while or after the pipe system (70) is inserted into the wellbore (110).

The pipe system (70) may be substantially identical to the first exemplary embodiment of the pipe system (70) which is depicted in FIGS. 5-7 or the second exemplary embodiment of the pipe system (70) which is depicted in FIGS. 8-10 and which have previously been described, or may be a different pipe system.

In the description of the exemplary method which follows, the pipe system (70) is substantially identical to the first exemplary embodiment of the pipe system (70) which is depicted in FIGS. 5-7.

The exemplary method comprises providing the pipe system (70), sealing a fluid (75) within the pipe bone (32) between the first plug assembly (72) and the second plug assembly (74), inserting the pipe system (70) into the wellbore (110), and unsealing the first plug assembly (72) and the second plug assembly (74). More particularly with reference to FIGS. 5-7, in the exemplary method, unsealing the first plug assembly (72) comprises unblocking the first primary channel (94) and unsealing the second plug assembly (74) comprises unblocking the second primary channel (104).

If the pipe system (70) is not pre-assembled or is only partially pre-assembled, providing the pipe system (70) may comprise assembling the pipe system (70). Depending upon the extent of pre-assembly of the pipe system (70), assembling the pipe system (70) may comprise one or more steps.

As a non-limiting example, assembling the pipe system (70) may comprise one or more of connecting lengths of the pipe (30) together to provide the pipe (30), inserting the first plug assembly (72) into the pipe bore (32) so that a seal is provided between the first sleeve (90) and the pipe (30), and/or inserting the second plug assembly (74) into the pipe bore (32) so that a seal is provided between the second sleeve (104) and the pipe (30). The required order for assembling the pipe system (70) may be dependent at least in part upon the specific configuration of the pipe system (70), including the pipe (30), the first plug assembly (72), and the second plug assembly (74).

In the exemplary method, assembling the pipe system (70) may comprise one or more of inserting the first plug assembly (72) into the proximal length (76) of the pipe (30), inserting the second plug assembly (74) into the distal length (78) of the pipe (30), connecting the distal end of the proximal length (76) of the pipe (30) with an intermediate length (80) of the pipe (30), connecting the proximal end of the distal length (78) of the pipe (30) with an intermediate length (80) of the pipe (30), interconnecting one or more additional intermediate lengths (80) of the pipe (80) between the first plug assembly (72) and the second plug assembly (74), connecting one or more additional lengths of the pipe (30) with the proximal end of the proximal length (76) of the pipe (30), and/or connecting one or more additional lengths of the pipe (30) with the distal end of the distal length (78) of the pipe (30).

Referring again to FIG. 8, in the exemplary method, the pipe system (70) is configured so that both the first plug assembly (70) and the second plug assembly (74) will be positioned in the deviated section (114) of the wellbore (110) for at least a portion of the insertion of the pipe system (70) into the wellbore (110). More particularly, in the exemplary method, the pipe system (70) is configured so that the first plug assembly (72) will be positioned adjacent to the proximal end of the deviated section (114) of the wellbore (110) and the second plug assembly (74) will be positioned toward the distal end of the deviated section (114) of the wellbore (110) after the pipe system (70) is fully inserted within the wellbore (110).

In the exemplary method, because the first plug assembly (72) and the second plug assembly (74) will both be positioned in the deviated section (114) of the wellbore (110) for at least a portion of the insertion of the pipe system (70) into the wellbore (110), the fluid (75) which is sealed within the pipe bore (32) is selected to be less dense than the wellborn fluid (116) which is likely to be contained in the wellbore (110), and/or less dense than the wellbore fluid (116) which is likely to be contained in the deviated section (114) of the wellbore (110).

In the exemplary method, the fluid (75) may be sealed within the pipe bore (32) in any suitable manner. As a non-limiting example, in the exemplary method, one or more of the intermediate lengths (80) of the pipe (30) may be provided with a sealable port (82) for enabling the fluid (75) to be introduced into the pipe bore (32) between the first plug assembly (72) and the second plug assembly (74). Alternatively as a non-limiting example, if the fluid (75) consists of air, the fluid (75) may naturally be sealed within the pipe bore (32) upon sealing of the pipe bore (32) with the plug assemblies (72,74).

In the exemplary method, inserting the pipe system (70) into the wellbore (110) is performed after the pipe system (70) has been provided and after the fluid (75) has been sealed within the pipe bore (32). Inserting the pipe system (70) into the wellbore (110) may be performed in any suitable manner including as non-limiting examples, by using a surface rig (118) with a rotary table (not shown) or a top-drive (not shown), or by using an injector apparatus (not shown).

Unblocking the first primary channel (94) and the second primary channel (104) may be performed in any suitable manner and in any suitable order.

In the exemplary method, the method comprises introducing a delivery fluid (120) into the pipe bore (32) proximal to the first plug assembly (72), wherein the delivery fluid (120) contains one or more disintegrating agents. In the exemplary method, the delivery fluid (120) comprises, consists of, or consists essentially of a wellbore fluid. In the exemplary method, the delivery fluid (120) say be introduced into the pipe bore (32) before the pipe system (70) is inserted within the wellbore (110) if the weight of the delivery fluid (120) in the pipe system (70) is desired during insertion, or the delivery fluid (120) may be introduced into the pipe bore (32) while or after the pipe system (70) is inserted into the wellbore (110) in order to unblock the first primary channel (94) and/or the second primary channel (104), and/or in order to deliver one or more disintegrating agents to the plug assemblies (72, 74).

In the exemplary method, unblocking the first primary channel (94) and the second primary channel (104) comprises unblocking the first primary channel (94), allowing the fluid (75) to mix with the delivery fluid within the pipe bore (32) to form a fluid mixture (not shown) comprising the fluid (75) and the delivery fluid (120), unblocking the second primary channel (104), and allowing the fluid mixture to drain through the second plug assembly (74).

In the exemplary method, unblocking the first primary channel (94) comprises increasing a pressure within the pipe bore (32) in order to break the shear pins which connect the first plug (92) with the first sleeve (90) and thereby release the first plug (92) from the first primary channel (94). In the exemplary method, increasing the pressure within the pipe bore (32) may comprise pressurizing the delivery fluid which is contained within the pipe bore (32) proximal to the first plug assembly (72).

In the exemplary method, unblocking the second primary channel (104) comprises increasing a pressure within the pipe bore (32) in order to break the burst plug which comprises the second plug (102) and thereby break the second plug (102). In the exemplary method, increasing the pressure within the pipe bore (32) may comprise pressurizing the fluid mixture and/or the delivery fluid which is contained in the pipe bore proximal to the second plug assembly (74).

In the exemplary method, the fluid (75) has a density less than that of the wellbore fluid (116) which is likely to be contained in the wellbore (110). As a result, a draining of the fluid (75) into the wellbore (110) from the second plug assembly (74) without first forming the fluid mixture may cause the wellbore (110) to become underbalanced, which may in turn cause production fluids to enter the wellbore (110) rapidly, potentially resulting in a “kick” and/or an uncontrollable wellbore (110).

As a result, in the exemplary method, allowing the fluid (75) to mix with the delivery fluid within the pipe bore (32) to form the fluid mixture may comprise separating the unblocking of the first primary channel (94) and the unblocking of the second primary channel (104) by a period of time to allow for the fluid (75) to mix with the delivery fluid. The period of time may be dependent upon the composition of the fluid (75), the composition of the delivery fluid, the first primary channel cross-sectional area (96), and/or the pressure, temperature and/or other environmental conditions within the wellbore (110). The fluid mixture will be more dense than the fluid (75), thus reducing the likelihood of causing an underbalanced wellbore (110) upon draining of the fluid mixture from the second plug assembly (74).

In the exemplary method, the method may therefore further comprise controlling and/or enhancing the mixing of the fluid (75) and the delivery fluid (120) to form the fluid mixture by selecting the compositions of the fluid (75) and the delivery fluid (120) and/or by selecting the first primary channel cross-sectional area (96). In the first exemplary embodiment of the pipe system (70) and the second exemplary embodiment of the pipe system (70), the first primary channel cross-sectional area (96) is greater than 50 percent of the bore cross-sectional area of the pipe bore (32), which may enhance the mixing of the fluid (75) with the delivery fluid.

In the exemplary method, the fluid mixture formed by mixing the fluid (75) with the delivery fluid may continue to have a density less than that of the wellbore fluid (116) which is likely to be contained in the wellbore (110). As a result, a rapid draining of the fluid mixture into the wellbore (110) from the second plug assembly (74) may continue to cause the wellbore (110) to become underbalanced.

As a result, in the exemplary method allowing the fluid mixture to drain through the second plug assembly (74) may comprise controlling a rate of draining of the fluid mixture from the second plug assembly (74) by selecting the second primary channel cross-sectional area (106). As a non-limiting example, the second primary channel cross-sectional area (106) may be selected so that the draining of the fluid mixture from the second plug assembly (74) is restricted and/or throttled in order to reduce the likelihood of the draining causing the wellbore (110) to become unbalanced. In the first exemplary embodiment of the pipe system (70), the second primary channel cross-sectional area (106) is less than 50 percent of the bore cross-sectional area of the pipe bore (32), which may restrict and/or throttle the draining of the fluid mixture from the second plug assembly (74).

The method may further comprise allowing one or more dissolvable components of the first plug assembly (72) and the second plug assembly (74) to dissolve in the presence of one or more disintegrating agents. The various dissolvable components may dissolve in the presence of the same disintegrating agent or agents, or in the presence of different disintegrating agents. In the exemplary method, the one or more disintegrating agents are contained in the delivery fluid (120), which may be contained within the pipe bore (32) proximal to the first plug assembly (72) when the pipe system (70) is inserted into the wellbore (110) or may be introduced into or enter the wellbore (110) while or after the pipe system (110) is inserted into the wellbore (110).

More particularly, in the exemplary method, the method may further comprise allowing the first sleeve (90) to dissolve in the presence of a first sleeve disintegrating agent and allowing the second sleeve (100) to dissolve in the presence of a second sleeve disintegrating agent, wherein the first sleeve disintegrating agent and the second sleeve disintegrating agent may be the same disintegrating agent or different disintegrating agents.

More particularly, in the exemplary method, if the first plug (92) is dissolvable in the presence of a first plug disintegrating agent, the method may comprise allowing the first plug (92) to dissolve in the presence of the first plug disintegrating agent.

More particularly in the exemplary method, if the second plug (102) is dissolvable in the presence of a second plug disintegrating agent, the method may comprise allowing the second plug (102) to dissolve in the presence of the second plug disintegrating agent.

More particularly, in the exemplary method, if components of the first plug assembly (72) and/or the second plug assembly (74) in addition to or in substitution for the first sleeve (90), the first plug (92), the second sleeve (100), and/or the second plug (102) are dissolvable in the presence of one or more disintegrating agents, the method may comprise allowing such components to dissolve in the presence of the one or more disintegrating agents. As non-limiting examples, in the exemplary method, the method may further comprise allowing the retaining device (50) to dissolve in the presence of a retaining device disintegrating agent, allowing the stop (52) associated with the first plug assembly (72) to dissolve in the presence of a stop disintegrating agent, and/or allowing the stop (52) associated with the second plug assembly (74) to dissolve in the presence of a stop disintegrating agent.

Finally, in the exemplary method, the method may comprise pumping the fluid mixture from the wellbore (110) and/or pumping non-dissolvable components of the first plug assembly (72) and the second plug assembly (74) from the wellbore (110).

A modified version of the exemplary method is now described in which the pipe system (70) is substantially identical to the second exemplary embodiment of the pipe system (70) which is depicted in FIGS. 8-10.

The description of the modified version of the exemplary method which follows is limited to those features of the modified version of the exemplary method which are additional to or different from the features of the exemplary method which has previously been described with reference to FIGS. 5-7.

In the modified version of the exemplary method, the second plug assembly (74) does not comprise a second sleeve (not shown in FIGS. 8-10), but comprises a second plug (102) having a second plug cross-sectional area (109) which is substantially equal to the bore cross-sectional area and which is therefore greater than 50 percent of the bore cross-sectional area. In the modified version of the exemplary method, the second plug (102) is positioned within the pipe bore (32) and blocks the pipe bore (32) such that a seal is provided between the second plug (102) and the pipe (30).

In the modified version of the exemplary method, unsealing the second plug assembly (74) therefore comprises releasing the second plug (102) from the pipe bore (32) in order to unblock the pipe bore (32). In the modified version of the exemplary method, releasing the second plug (102) from the pipe bore (32) and thus unblocking the plug bore (32) comprises increasing a pressure within the pipe bore (32) in order to break the shear pins which connect the second plug (103) with the distal length (73) of the pipe (30). In the modified version of the exemplary method, increasing the pressure within the pipe bore (32) may comprise pressurizing the delivery fluid which is contained within the pipe bore (32) proximal to the second plug assembly (74).

In the modified version of the exemplary method, releasing the second plug (102) from the pipe bore (32) may result in a rapid draining of the fluid mixture into the wellbore (110) from the second plug assembly (74). If the delivery fluid and/or the fluid mixture which is contained in the pipe bore (32) proximal to the second plug assembly (74) is substantially less dense than the wellbore fluid (116) which is likely to be contained in the wellbore (110), this rapid draining may cause the wellbore (110) to become unbalanced and may result in a “kick” and/or an uncontrollable wellbore (110).

As a result, the modified version of the exemplary method may be particularly suited for applications of the method in which the fluid (75) which is sealed between the first plug assembly (72) and the second plug assembly (74) is not substantially less dense than the wellbore fluid (116) which is likely to be contained in the wellbore (110).

The modified version of the exemplary method may further comprise allowing the first sleeve (90) to dissolve in the presence of a first sleeve disintegrating agent.

If the first plug (92) is dissolvable in the presence of a first plug disintegrating agent, the modified version of the exemplary method may comprise allowing the first plug (92) to dissolve in the presence of the first plug disintegrating agent.

If the second plug (102) is dissolvable in the presence of a second plug disintegrating agent, the modified version of the exemplary method may comprise allowing the second plug (102) dissolve in the presence of the second plug disintegrating agent.

If components of the first plug assembly (72) and/or the second plug assembly (74) in addition to or in substitution for the first sleeve (90), the first plug (92), and/or the second plug (102) are dissolvable in the presence of one or more disintegrating agents, the modified version of the exemplary method may comprise allowing such components to dissolve in the presence of the one or more disintegrating agents. As non-limiting examples, the modified version of the exemplary method may further comprise slowing the retaining device (50) associated with the first plug (92) to dissolve in the presence of a retaining device disintegrating agent, allowing the retaining device (50) associated with the second lug (102) to dissolve in the presence of a retaining device disintegrating agent, allowing the stop (52) associated with the first plug assembly (72) to dissolve in the presence of a stop disintegrating agent, and/or allowing the stop (52) associated with the second plug assembly (74) to dissolve in the presence of a stop disintegrating agent.

In this document, the word “comprising” is used in its non-limiting sense to mean that items following the word are included, but not specifically mentioned are not excluded. A reference to an element by the indefinite article “a” does not exclude the possibility that more than one of the elements is present, unless the context clearly requires that there be one and only one of the elements.

1. A plug assembly for sealing a pipe bore of a pipe, comprising:
(a) a dissolvable sleeve for positioning within the pipe bore such that a seal is provided between the sleeve and the pipe, wherein the sleeve has a proximal end and a distal end, wherein the sleeve defines a primary channel extending through the sleeve from the proximal end to the distal end, wherein the sleeve is dissolvable in the presence of a sleeve disintegrating agent; and
(b) a plug blocking the primary channel.

2. The plug assembly as claimed in claim 1, wherein the sleeve comprises a metal alloy which is dissolvable in the presence of the sleeve disintegrating agent.

3. The plug assembly as claimed in claim 2, wherein the metal alloy is a dissolvable magnesium alloy.

4. The plug assembly as claimed in claim 1, wherein the sleeve is shaped to enhance a rate at which the sleeve dissolves.

5. The plug assembly as claimed in claim 4, wherein the sleeve is shaped so that it defines a plurality of secondary channels in communication with at least one of the primary channel, the proximal end of the sleeve, and the distal end of the sleeve, for enhancing the rate at which the sleeve dissolves.

6. The plug assembly as claimed in claim 5, wherein the secondary channels are in communication with the primary channel.

7. The plug assembly as claimed in claim 1, wherein the pipe bore has a bore cross-sectional area, wherein the primary channel has a primary channel cross-sectional area, and wherein the primary channel cross-sectional area is less than 50 percent of the bore cross-sectional area.

8. The plug assembly as claimed in claim 7, wherein the sleeve is shaped so that it defines a plurality of secondary channels in communication with the primary channel for enhancing the rate at which the sleeve dissolves.

9. The plug assembly as claimed in claim 1, wherein the pipe bore has a bore cross-sectional area, wherein the primary channel has a primary channel cross-sectional area, and wherein the primary channel cross-sectional area is greater than 50 percent of the bore cross-sectional area.

10. The plug assembly as claimed in claim 9, wherein the sleeve is shaped so that it defines a plurality of secondary channels in communication with at least one of the primary channel, the proximal end of the sleeve, and the distal end of the sleeve, for enhancing the rate at which the sleeve dissolves.

11. The plug assembly as claimed in claim 1, wherein the plug is breakable to unblock the primary channel.

12. The plug assembly as claimed in claim 11, wherein the plug is breakable by increasing a pressure within the pipe bore.

13. The plug assembly as claimed in claim 11, wherein the plug comprises a burst plug.

14. The plug assembly as claimed in claim 1, further comprising a retaining device for retaining the plug within the primary channel.

15. The plug assembly as claimed in claim 14, wherein the retaining device is releasable to release the plug from the primary channel, thereby unblocking the primary channel.

16. The plug assembly as claimed in claim 15, wherein the retaining device is releasable by increasing a pressure within the pipe bore.

17. The plug assembly as claimed in claim 15, wherein the retaining device comprises one or more shear pins.

18. The plug assembly as claimed in claim 14, wherein the retaining device is dissolvable in the presence of a retaining device disintegrating agent.

19. The plug assembly as claimed in claim 1, wherein the plug is dissolvable in the presence of a plug disintegrating agent.

20. The plug assembly as claimed in claim 19, wherein the plug comprise a metal alloy which is dissolvable in the presence of the plug disintegrating agent.

21. The plug assembly as claimed in claim 20, wherein the metal alloy is a dissolvable magnesium alloy.

22. A pipe system comprising:
(a) a pipe, wherein the pipe defines a pipe bore;
(b) a first plug assembly sealing the pipe bore and a second plug assembly sealing the pipe bore, wherein the second plug assembly is separated from the first plug assembly by a distance within the pipe bore, wherein the second plug assembly is distal to the first plug assembly, and wherein at least one of the first plug assembly and the second plug assembly comprises:
(i) a dissolvable sleeve positioned within the pipe bore such that a seal is provided between the sleeve and the pipe, wherein the sleeve has a proximal aid and a distal end, wherein the sleeve defines a primary channel extending through the sleeve from the proximal end to the distal end, wherein the sleeve is dissolvable in the presence of a sleeve disintegrating agent; and
(ii) a plug blocking the primary channel; and
(c) a fluid sealed within the pipe bore between the first plug assembly and the second plug assembly.

23. The pipe system as claimed in claim 22, wherein the first plug assembly comprises:
(i) a dissolvable first sleeve positioned within the pipe bore such that a seal is provided between the first sleeve and the pipe, wherein the first sleeve has a proximal end and a distal end, wherein the first sleeve defines a first primary channel extending through the first sleeve from the proximal end to the distal end, wherein the first sleeve is dissolvable in the presence of a first sleeve disintegrating agent; and
(ii) a first plug blocking the first primary channel.

24. The pipe system as claimed in claim 22, wherein the second plug assembly comprises:
(i) a dissolvable second sleeve positioned within the pipe bore such that a seal is provided between the second sleeve and the pipe, wherein the second sleeve has a proximal end and a distal end, wherein the second sleeve from the proximal end to the distal end, wherein the second sleeve is dissolvable in the presence of a second sleeve disintegrating agent; and
(ii) a second plug blocking the second primary channel.

25. The pipe system as claimed in claim 23, wherein the second plug assembly comprises a second plug.

26. The pipe system as claimed in claim 25, wherein the second plug assembly further comprises a second sleeve positioned within the pipe bore such that a seal is provided between the second sleeve and the pipe, wherein the second sleeve has a proximal end and a distal end, wherein the second sleeve defines a second primary channel extending through the second sleeve from the proximal end to the distal end, and wherein the second plug blocks the primary channel.

27. The pipe system as claimed in claim 26, wherein the second sleeve is dissolvable in the presence of a second sleeve disintegrating agent.

28. The pipe system as claimed in claim 27, wherein the pipe bore has a bore cross-sectional area, wherein the second primary channel has a second primary channel cross-sectional area, and wherein the second primary channel cross-sectional area is less than 50 percent of the bore cross-sectional area.

29. The pipe system as claimed in claim 28, wherein the second sleeve is shaped so that it defines a plurality of secondary channels in communication with the second primary channel for enhancing a rate at which the second sleeve dissolves, and wherein the second plug blocks the second primary channel, so that it prevents communication between the distal end of the second sleeve and at least some of the secondary channels.

30. The pipe system as claimed in claim 27, wherein the pipe bore has a bore cross-sectional area, wherein the first primary channel has a first primary channel cross-sectional area, and wherein the first primary channel cross-sectional area is greater than 50 percent of the bore cross-sectional area.

31. The pipe system as claimed in claim 30, wherein the first plug is dissolvable in the presence of a first plug disintegrating agent.

32. The pipe system as claimed in claim 27, wherein the fluid sealed within the pipe bore between the first plug assembly and the second plug assembly is less dense than a wellbore fluid.

33. The pipe system as clamed in claim 27, wherein the fluid sealed within the pipe bore between the first plug assembly and the second plug assembly comprises air.

34. The pipe system is claimed in claim 27, further comprising a third plug assembly sealing the pipe bore, wherein the third plug assembly is separated from the first plug assembly by a distance within the pipe bore, and wherein the third plug assembly is proximal to the first plug assembly.

35. The pipe system as claimed in claim 25, wherein the pipe bore has a bore cross-sectional area, wherein the second plug has a second plug cross-sectional area, and wherein the second plug cross-sectional area is greater than 50 percent of the bore cross-sectional area.

36. The pipe system as claimed in claim 35, wherein the second plug is dissolvable in the presence of a second plug disintegrating agent.

37. The pipe system as claimed in claim 25, wherein the pipe bore has a bore cross-sectional area, wherein the first primary channel has a first primary channel cross-sectional area, and wherein the first primary channel cross-sectional area is greater than 50 percent of the bore cross-sectional area.

38. The pipe system as claimed in claim 37, wherein the first plug is dissolvable in the presence of a first plug disintegrating agent.

39. The pipe system as claimed in claim 25, wherein the fluid seated within the pipe bore between the first plug assembly and the second plug assembly is less dense than a wellbore fluid.

40. The pipe system as claimed in claim 39, wherein the fluid sealed within the pipe bore between the first plug assembly and the second plug assembly comprises air.

41. The pipe system as claimed in claim 25, further comprising a third plug assembly sealing the pipe bore, wherein the third plug assembly is separated from the first plug assembly by a distance within the pipe bore, and wherein the third plug assembly is proximal to the first plug assembly.

42. A method for insuring a pipe system into a wellbore comprising:
(a) providing the pipe system, wherein the pipe system comprises:
(i) a pipe wherein the pipe defines a pipe bore;
(ii) a first plug assembly sealing the pipe bore and a second plug assembly sealing the pipe bore, wherein the second plug assembly is separated from the first plug assembly by a distance within the pipe bore, wherein the second plug assembly is distal to the first plug assembly, and wherein at least one of the first plug assembly and the second plug assembly comprises:
(i) a dissolvable sleeve positioned within the pipe bore such that a seal is provided between the sleeve and the pipe, wherein the sleeve has a proximal end and a distal end, wherein, the sleeve defines a primary channel extending through the sleeve from the proximal end to the distal end, wherein the sleeve is dissolvable in the presence of a sleeve disintegrating agent; and
(ii) a plug blocking the primary channel; and
(b) sealing a fluid within the pipe bore between the first plug assembly and the second plug assembly;
(c) inserting the pipe system into the wellbore; and
(d) unsealing the first plug assembly and the second plug assembly.

43. The method as claimed in claim 42, wherein the first plug assembly comprises:
(i) a dissolvable first sleeve positioned within the pipe bore such that a seal is provided between the first sleeve and the pipe, wherein the first sleeve has a proximal end and a distal end, wherein the first sleeve defines a first primary channel extending through the first sleeve from the proximal end to the distal end, wherein the first sleeve is dissolvable in the presence of a first sleeve disintegrating agent; and
(ii) a first plug blocking the first primary channel.

44. The method as claimed in claim 42, wherein the second plug assembly comprises:
(i) a dissolvable second sleeve positioned within the pipe bore such that a seal is provided between the second sleeve and the pipe, wherein the second sleeve has a proximal end and a distal end, wherein the second sleeve defines a second primary channel extending through the second sleeve from the proximal end to the distal and, wherein the second sleeve is dissolvable in the presence of a second sleeve disintegrating agent; and
(ii) a second plug blocking the second primary channel.

45. The method as claimed in claim 43, wherein the second plug assembly comprises a second plug.

46. The method as claimed in claim 45, wherein the second plug assembly further comprises a second sleeve positioned within the pipe bore such that a seal is provided between the second sleeve and the pipe, wherein the second sleeve has a proximal end and a distal end, wherein the second sleeve defines a second primary channel extending through the second sleeve from the proximal end to the distal end, and wherein the second plug blocks the second primary channel.

47. The method as claimed in claim 46, wherein the second sleeve is dissolvable in the presence of a second sleeve disintegrating agent.

48. The method as claimed in claim 47, wherein the first sleeve disintegrating agent and the second sleeve disintegrating agent are contained in a delivery fluid, further comprising introducing the delivery fluid into the pipe bore proximal to the first plug assembly.

49. The method as claimed in claim 48, wherein unsealing the first plug assembly and the second plug assembly comprises unblocking the first primary channel and unblocking the second primary channel.

50. The method as claimed in claim 49, wherein unblocking the first primary channel and unblocking the second primary channel comprises unblocking the first primary channel, allowing the fluid to mix with the delivery fluid within the pipe bore to form a fluid mixture, unblocking the second primary channel and allowing the fluid mixture to drain through the second plug assembly.

51. The method as claimed in claim 50, wherein the pipe bore has a bore cross-sectional area, wherein the first primary channel has a first primary channel cross-sectional area, and wherein the first primary channel cross-sectional area is greater than 50 percent of the bore cross-sectional area.

52. The method as claimed in claim 50, wherein the second primary channel has a second primary channel cross-sectional area, further comprising controlling a rate of draining of the fluid mixture from the second plug assembly by selecting the second primary channel cross-sectional area.

53. The method as claimed in claim 52, wherein the pipe bore has a bore cross-sectional area, and wherein the second primary channel cross-sectional area is selected to be less than 50 percent of the bore cross-sectional area.

54. The method as claimed in claim 51, wherein the first plug is dissolvable in the presence of the first plug disintegrating agent, further comprising allowing the first plug to dissolve in the presence of the first plug disintegrating agent.

55. The method as claimed in claim 54, wherein the first plug disintegrating agent is contained in the delivery fluid.

56. The method as claimed in claim 50, further comprising pumping the fluid mixture from the wellbore.

57. The method as claimed in claim 49, wherein unblocking at least one of the first primary channel and the second primary channel comprises increasing a pressure within the pipe bore.

58. The method as claimed in claim 49, further comprising allowing the first sleeve to dissolve in the presence of the first sleeve disintegrating agent, and further comprising allowing the second sleeve to dissolve in the presence of the second sleeve disintegrating agent.

59. The method as claimed in claim 49, further comprising pumping non-dissolvable components of the first plug assembly and the second plug assembly out of the pipe bore after unblocking the first primary channel and the second primary channel.

60. The method as claimed in claim 49, wherein the fluid sealed within the pipe bore between the first plug assembly and the second plug assembly is less dense than a wellbore fluid.

61. The method as claimed in claim 49, wherein the fluid sealed within the pipe bore between the first plug assembly and the second plug assembly comprises air.

62. The method as claimed in claim 45, wherein the first sleeve disintegrating agent is contained in a delivery fluid, further comprising introducing the delivery fluid into the pipe bore proximal to the first plug assembly.

63. The method as claimed in claim 62, wherein unsealing the first plug assembly comprises unblocking the first primary channel.

64. The method as claimed in claim 62, wherein unsealing the first plug assembly and unsealing the second plug assembly comprises unblocking the first primary channel, allowing the fluid to mix with the delivery fluid within the pipe bore to form a fluid mixture, unsealing the second plug assembly, and allowing the fluid mixture to drain through the second plug assembly.

65. The method as claimed in claim 64, wherein the pipe bore has a bore cross-sectional area, wherein the first primary channel has a first primary channel cross-sectional area, and wherein the first primary channel cross-sectional area is greater than 50 percent of the bore cross-sectional area.

66. The method as claimed in claim 64, wherein the pipe bore has a bore cross-sectional area, wherein the second plug has a second plug cross-sectional area, and wherein the second plug cross-sectional area is greater than 50 percent of the bore cross-sectional area.

67. The method as claimed in claim 66, wherein the first plug is dissolvable in the presence of a first plug disintegrating agent, further comprising allowing the first plug to dissolve in the presence of the first plug disintegrating agent.

68. The method as claimed in claim 67, wherein the first plug disintegrating agent is contained in the delivery fluid.

69. The method as claimed, in claim 66, wherein the second plug is dissolvable in the presence of a second plug disintegrating agent, further comprising allowing the second plug to dissolve in the presence of the second plug disintegrating agent.

70. The method as claimed in claim 69, wherein the second plug disintegrating agent is contained in the delivery fluid.

71. The method as claimed in claim 64, further comprising pumping the fluid mixture from the wellbore.

72. The method as claimed in claim 63, wherein at least one of unblocking the first primary channel and unsealing the second plug assembly comprises increasing a pressure within the pipe bore.

73. The method as claimed in claim 63, further comprising allowing the first sleeve to dissolve in the presence of the first sleeve disintegrating agent.

74. The method as claimed in claim 63, further comprising pumping non-dissolvable components of the first plug assembly and the second plug assembly out of the pipe bore after unblocking the first primary channel and unsealing the second plug assembly.

75. The method as claimed in claim 63, wherein the fluid sealed within the pipe bore between the first plug assembly and the second plug assembly is less dense than a wellbore fluid.

76. The method as claimed in claim 63, wherein the fluid sealed within the pipe bore between the first plug assembly and the second plug assembly comprises air.
